(19) United States
(12) Patent Application Publication
(10) Pub. No.: US 2021/0311087 A1
(43) Pub. Date: Oct. 7, 2021

(54) SCATTERER MEASUREMENT METHOD AND SCATTERER MEASUREMENT APPARATUS

(71) Applicant: Panasonic Intellectual Property Management Co., Ltd., Osaka (JP)

(72) Inventors: MARIKO MIYASHITA, Hyogo (JP); TATSUSHI OHYAMA, Osaka (JP)

(21) Appl. No.: 17/347,440

(22) Filed: Jun. 14, 2021

Related U.S. Application Data
(63) Continuation of application No. PCT/JP2020/004401, filed on Feb. 5, 2020.

(30) Foreign Application Priority Data
Feb. 26, 2019 (JP) 2019-033246
Mar. 28, 2019 (JP) 2019-064840
Jan. 24, 2020 (JP) 2020-009710

(51) Int. Cl. G01P 3/68

(52) U.S. Cl. CPC G01P 3/68

(57) ABSTRACT

A scatterer measurement method includes: radiating a first irradiating light that passes through a first space in which a scatterer is present; receiving a first scattered light produced by the first irradiating light being scattered by the scatterer; after the scatterer has moved from the first space to a second space at least partially different from the first space, radiating a second irradiating light that passes through the second space; receiving a second scattered light produced by the second irradiating light being scattered by the scatterer; and calculating a velocity of the scatterer based on a difference between a first point in time at which the first scattered light was received and a second point in time at which the second scattered light was received and a distance that the scatterer moved during a period from the first point in time to the second point in time.

### BACKGROUND

### 1. Technical Field

The present disclosure relates to a scatterer measurement method and a scatterer measurement apparatus.

### 2. Description of the Related Art

Major routes of infection with infectious diseases such as influenza include droplet infection and contact infection. Droplet infection is a process by which a person directly takes, though the mouth or the nose into the body, a virus contained in droplets that an infected person coughed or sneezed. Further, contact infection is a process by which a person takes a virus into the body by touching a place such as a desk or a floor laden with droplets. It is expected that such infection starting from droplets will be controlled by detecting the presence of droplets as appropriate in a room and removing the droplets.

In line with this expectation, for example, Japanese Unexamined Patent Application Publication No. 2017-117416 and Japanese Unexamined Patent Application Publication No. 2015-143592 disclose, as ways of detecting a human cough from which droplets originate, technologies with which to detect the act of coughing with a sound sensor such as an acceleration sensor or a microphone.

### SUMMARY

In one general aspect, the techniques disclosed here feature a scatterer measurement method including: radiating a first irradiating light that passes through a first space in which a scatterer is present; receiving a first scattered light produced by the first irradiating light being scattered by the scatterer; after the scatterer has moved from the first space to a second space at least partially different from the first space, radiating a second irradiating light that passes through the second space; receiving a second scattered light produced by the second irradiating light being scattered by the scatterer; and calculating a velocity of the scatterer based on a difference between a first point in time at which the first scattered light was received and a second point in time at which the second scattered light was received and a distance that the scatterer moved during a period from the first point in time to the second point in time.

Further, in one general aspect, the techniques disclosed here feature a scatterer measurement apparatus including: a light source that radiates a first irradiating light that passes through a first space in which a scatterer is present; a photosensitive element that receives a first scattered light produced by the first irradiating light being scattered by the scatterer; and a signal processing circuit, wherein after the scatterer has moved from the first space to a second space at least partially different from the first space, the light source further radiates a second irradiating light that passes through the second space, the photosensitive element further receives a second scattered light produced by the second irradiating light being scattered by the scatterer, and the signal processing circuit calculates a velocity of the scatterer based on a difference between a first point in time at which the first scattered light was received and a second point in time at which the second scattered light was received and a distance that the scatterer moved during a period from the first point in time to the second point in time.

Further, an aspect of the present disclosure may be implemented as a program for causing a computer to execute the scatterer measurement method. Alternatively, the present disclosure may be implemented as a non-transitory computer-readable recording medium storing the program.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram schematically showing an example of a configuration of a scatterer measurement apparatus according to Embodiment 1;

FIG. 2 is a diagram schematically showing how aerosol particles are detected by the scatterer measurement apparatus according to Embodiment 1;

FIG. 3A is a diagram showing an example of a target space;

FIG. 3B is a diagram showing examples of unit spaces obtained by virtually dividing the target space;

FIG. 4A is a diagram for explaining a method for calculating the velocity of aerosol particles with the scatterer measurement apparatus according to Embodiment 1;

FIG. 4B is a diagram for explaining a method for calculating the velocity of aerosol particles with the scatterer measurement apparatus according to Embodiment 1;

FIG. 5 is a flow chart showing an example of an operation of the scatterer measurement apparatus according to Embodiment 1;

FIG. 6 is a diagram schematically showing an example of a configuration of a scatterer measurement apparatus according to Embodiment 2;

FIG. 7 is a diagram schematically showing how aerosol particles are detected by the scatterer measurement apparatus according to Embodiment 2;

FIG. 8 is a flow chart showing an example of an operation of the scatterer measurement apparatus according to Embodiment 2;

FIG. 9 is a diagram schematically showing how aerosol particles are detected by a scatterer measurement apparatus according to Embodiment 3;

FIG. 10 is a flow chart showing an example of an operation of the scatterer measurement apparatus according to Embodiment 3;

FIG. 11 is a diagram schematically showing an example of a configuration of a scatterer measurement apparatus according to Embodiment 4;

FIG. 12 is a diagram schematically showing a configuration of a scatterer measurement apparatus according to Embodiment 5;

FIG. 13A is a diagram showing aerosol particles during irradiation with a first irradiating light by the scatterer measurement apparatus according to Embodiment 5;

FIG. 13B is a diagram showing the aerosol particles during irradiation with a second irradiating light by the scatterer measurement apparatus according to Embodiment 5;

FIG. 14 is a diagram showing a relationship between the particle diameter and falling velocity of aerosol particles;

FIG. 15 is a flow chart showing an operation of the scatterer measurement apparatus according to Embodiment 5;

FIG. 16 is a diagram schematically showing a configuration of a scatterer measurement apparatus according to Embodiment 6;

FIG. 17 is an example of a three-dimensional florescence spectrum of saliva;

FIG. 18 is an example of a three-dimensional florescence spectrum of cedar pollen;

FIG. 19 is a flow chart showing an operation of the scatterer measurement apparatus according to Embodiment 6; and

FIG. 20 is a diagram schematically showing a configuration of a scatterer measurement apparatus according to Embodiment 7.

### DETAILED DESCRIPTION

The conventional technologies can only identify a place where a cough has occurred, and fail to show a direction or a range in or over which droplets have actually diffused. This makes it impossible to present a risk source of infection as appropriate or remove a virus or other substances contained in the droplets. This also makes it impossible to detect a scatterer other than the droplets, such as pollen or PM_{2.5}, that may harm human health.

To address this problem, the present disclosure provides a scatterer measurement method and a scatterer measurement apparatus that make it possible to detect the position of a scatterer with a high degree of accuracy and assist in identifying the type of the scatterer.

### Brief Overview of the Present Disclosure

In one general aspect, the techniques disclosed here feature a scatterer measurement method includes: radiating a first irradiating light that passes through a first space in which a scatterer is present; receiving a first scattered light produced by the first irradiating light being scattered by the scatterer; after the scatterer has moved from the first space to a second space at least partially different from the first space, radiating a second irradiating light that passes through the second space; receiving a second scattered light produced by the second irradiating light being scattered by the scatterer; and calculating a velocity of the scatterer on the basis of a difference between a first point in time at which the first scattered light was received and a second point in time at which the second scattered light was received and a distance that the scatterer moved during a period from the first point in time to the second point in time.

This makes it possible to accurately calculate the position and velocity of the scatterer on the basis of the direction in which irradiating light was radiated and the time until scattered light returns. Further, the velocity thus calculated may be used, for example, to determine the type of the scatterer or estimate the range of diffusion of the scatterer. This makes it possible to detect the position of the scatterer with a high degree of accuracy and assist in determining the type of the scatterer.

Further, for example, in the scatterer measurement method according to the aspect of the present disclosure, the first space and the second space may each be one of a plurality of unit spaces each having a predetermined shape, the plurality of unit spaces being obtained by virtually dividing a target space to be measured by the scatterer measurement method.

This makes it possible to make the first space and the second space the same in size and therefore makes it easy to compare the intensities of the first scattered light and the second scattered light, which return from the first space and the second space, respectively. This makes it possible to accurately determine that the scatterer has moved from the first space and is present in the second space, and therefore makes it possible to increase the accuracy of calculation of the velocity of the scatterer.

Further, for example, in the scatterer measurement method according to the aspect of the present disclosure, the second pace may be a unit space, included in the plurality of unit spaces, that is adjacent to the first space.

As a result, the movement of the scatterer is detected by utilizing two adjacent unit spaces. This makes it possible to accurately calculate the velocity of the scatterer before the scatterer widely diffuses.

Further, for example, in the scatterer measurement method according to the aspect of the present disclosure, the first space may be a space in which at least a part of a head of a person is present or a space closest to at least a part of a head of a person.

This makes it possible to detect droplets just forced out of the mouth of the person and therefore makes the velocity that is calculated equal to the velocity of the droplets. This makes it possible to increase the accuracy of determination of the droplets by a comparison between the velocity and a threshold.

Further, for example, the scatterer measurement method according to the aspect of the present disclosure may further include, before radiating the first irradiating light, identifying the space in which at least the part of the head is present or the space closest to at least the part of the head as the first space.

This makes it possible to identify the position of the head of the person before radiating the first irradiating light and therefore makes it possible to quickly detect droplets being forced out of the mouth of the person.

Further, for example, the scatterer measurement method according to the aspect of the present disclosure may further include comparing the velocity with a threshold and, in a case where the velocity is greater than or equal to the threshold, identifying the scatterer as droplets forced out of a mouth of a person.

This determines whether the scatterer is droplets, and therefore makes it possible to accurately detect the direction and range of diffusion of the droplets.

Further, for example, in the scatterer measurement method according to the aspect of the present disclosure, the threshold may be 5 m/s.

The initial velocity of droplets forced out of the mouth of a person is greater than or equal to approximately 8 m/s. Further, aerosol particles other than droplets are usually suspended in air at a sufficiently lower velocity than droplets. Accordingly, since the threshold is 5 m/s, this makes it possible to accurately determine whether the scatterer is droplets.

Further, for example, in the scatterer measurement method according to the aspect of the present disclosure, the first irradiating light and the second irradiating light may each be light having equal frequency intervals, receiving the first scattered light may include receiving the first scattered light having passed through an interferer capable of varying optical path difference, receiving the second scattered light may include receiving the second scattered light having passed through the interferer, and calculating the velocity may include extracting a signal component corresponding to a first interference fringe of each of the first scattered light and the second scattered light obtained by sweeping the optical path difference, and calculating the velocity on the basis of the signal component.

Scattered light not only contains Mie scattered light from aerosol particles but also contains, as a noise component, Rayleigh scattered light based on molecules that make up air. To address this problem, the present aspect makes it possible to remove the Rayleigh scattered light by signal processing and therefore makes it possible to increase the accuracy of detection of the aerosol particles.

Further, for example, in the scatterer measurement method according to the aspect of the present disclosure, the optical path difference that the interferer sweeps may be longer than ¼ of a center wavelength of each of the first irradiating light and the second irradiating light and shorter than ½ of an interval between interference fringes of each of the first scattered light and the second scattered light.

This makes it possible to accurately remove Rayleigh scattered light by signal processing and therefore makes it possible to further increase the accuracy of detection of the aerosol particles.

Further, for example, in the scatterer measurement method according to the aspect of the present disclosure, at least one selected from the group consisting of the first irradiating light and the second irradiating light may be polarized light, and the velocity may be a falling velocity of the scatterer. The scatterer measurement method may further include measuring a depolarization ratio of scattered light corresponding to the polarized light, the scattered light being at least one selected from the group consisting of the first scattered light and the second scattered light.

This makes it possible to, by using the depolarization ratio and the falling velocity, identify the type of a detected scatterer.

Further, for example, the scatterer measurement method according to the aspect of the present disclosure may further include: making a first determination on the basis of the depolarization ratio as to whether the scatterer is aspherical particles; and in a case where the scatterer has been identified as not being aspherical particles, making a second determination on the basis of the falling velocity as to whether the scatterer is PM_{2.5}.

This makes it possible to, by using the depolarization ratio and the falling velocity, determine whether a detected scatterer is aspherical particles such as house dust or PM_{2.5}.

Further, for example, in the scatterer measurement method according to the aspect of the present disclosure, the first determination may include identifying the scatterer as aspherical particles in a case where the depolarization ratio is greater than or equal to 10% and identifying the scatterer as not being aspherical particles in a case where the depolarization ratio is less than 10%.

This makes it possible to more accurately discriminate aspherical particles such as house dust.

Further, for example, in the scatterer measurement method according to the aspect of the present disclosure, the second determination may include identifying the scatterer as PM_{2.5} in a case where the falling velocity is less than 0.001 m/s.

This makes it possible to more accurately discriminate PM_{2.5}, which may affect the respiratory organs.

Further, for example, in the scatterer measurement method according to the aspect of the present disclosure, the first irradiating light and the second irradiating light may each be light not containing a fluorescence wavelength component of droplets, and the second determination may include (a) identifying the scatterer as pollen in a case where the falling velocity is greater than or equal to 0.001 m/s and an intensity of light received of a wavelength component longer than or equal to 400 nm and shorter than or equal to 1000 nm contained in the scattered light is greater than a threshold, and (b) identifying the scatterer as droplets in a case where the falling velocity is greater than or equal to 0.001 m/s and the intensity of light received of the wavelength component longer than or equal to 400 nm and shorter than or equal to 1000 nm contained in the scattered light is less than or equal to the threshold.

This makes it possible to more accurately discriminate between pollen that may produce allergy symptoms and droplets that pose a risk of becoming infected with a disease.

Further, for example, in the scatterer measurement method according to the aspect of the present disclosure, the second determination may include identifying the scatterer as droplets in a case where the falling velocity is greater than or equal to 0.1 m/s.

This makes it possible to accurately discriminate droplets.

Further, for example, in the scatterer measurement method according to the aspect of the present disclosure, the second determination may include identifying the scatterer as pollen in a case where the falling velocity is greater than or equal to 0.001 m/s and less than 0.1 m/s.

This makes it possible to accurately discriminate pollen.

Further, for example, in the scatterer measurement method according to the aspect of the present disclosure, the second space may be located vertically below the first space.

This makes it easy for scattered light from a fallen scatterer to be received and therefore makes it possible to easily and accurately calculate the falling velocity. The increase in accuracy of calculation of the falling velocity can lead to an increase in accuracy of identification of the type of the scatterer.

Further, in one general aspect, the techniques disclosed here feature a program that causes a computer to execute the scatterer measurement method.

This makes it possible to detect the position of a scatterer with a high degree of accuracy and assist in determining the type of the scatterer.

Further, in one general aspect, the techniques disclosed here feature a non-transitory computer-readable recording medium storing a program for measuring a scatterer, which when executed by a computer, causes the computer to perform an operation including: radiating a first irradiating light that passes through a first space in which a scatterer is present; receiving a first scattered light produced by the first irradiating light being scattered by the scatterer; after the scatterer has moved from the first space to a second space at least partially different from the first space, radiating a second irradiating light that passes through the second space; receiving a second scattered light produced by the second irradiating light being scattered by the scatterer; and calculating a velocity of the scatterer on the basis of a difference between a first point in time at which the first scattered light was received and a second point in time at which the second scattered light was received and a distance that the scatterer moved during a period from the first point in time to the second point in time.

Further, in one general aspect, the techniques disclosed here feature a scatterer measurement apparatus including: a light source that radiates a first irradiating light that passes through a first space in which a scatterer is present; a photosensitive element that receives a first scattered light produced by the first irradiating light being scattered by the scatterer; and a signal processing circuit. After the scatterer has moved from the first space to a second space at least partially different from the first space, the light source further radiates a second irradiating light that passes through the second space. The photosensitive element further receives a second scattered light produced by the second irradiating light being scattered by the scatterer, and the signal processing circuit calculates a velocity of the scatterer on the basis of a difference between a first point in time at which the first scattered light was received and a second point in time at which the second scattered light was received and a distance that the scatterer moved during a period from the first point in time to the second point in time.

This makes it possible to detect the position of a scatterer with a high degree of accuracy and assist in determining the type of the scatterer.

Further, for example, the scatterer measurement apparatus according to the aspect of the present disclosure may further include a first polarizing filter that polarizes at least one selected from the group consisting of the first irradiating light and the second irradiating light radiated from the light source; a beam splitter that splits, into a third scattered light and a fourth scattered light, scattered light corresponding to the light polarized by the first polarizing filter, the scattered light being at least one selected from the group consisting of the first scattered light and the second scattered light; a second polarizing filter, disposed on an optical path of the third scattered light, that transmits a polarization component parallel to a plane of polarization of the light polarized by the first polarizing filter; and a third polarizing filter, disposed on an optical path of the fourth scattered light, that transmits a polarization component perpendicular to the plane of polarization of the light polarized by the first polarizing filter. The photosensitive element may include a first photosensitive element that receives the third scattered light having passed through the second polarizing filter, and a second photosensitive element that receives the fourth scattered light having passed through the third polarizing filter, the velocity may be a falling velocity of the scatterer, and the signal processing circuit may further acquire a depolarization ratio on the basis of an intensity of the third scattered light received by the first photosensitive element and an intensity of the fourth scattered light received by the second photosensitive element, determine, on the basis of the depolarization ratio, whether the scatterer is aspherical particles, and, in a case where the scatterer has been identified as not being aspherical particles, determine, on the basis of the falling velocity, whether the scatterer is PM_{2.5}.

This makes it possible to easily calculate the depolarization ratio by using two polarizing filters and two photosensitive elements. This also makes it possible to, by using the depolarization ratio and the falling velocity, identify the type of a detected scatterer.

Further, for example, an aerosol analysis apparatus serving as an example of the scatterer measurement apparatus according to the aspect of the present disclosure includes a light source that radiates irradiating light toward aerosol particles, a photodetector that receives scattered light generated by the aerosol particles scattering the irradiating light and that outputs a signal corresponding to an intensity of light received, and a signal processing circuit that processes a signal outputted from the photodetector. The signal processing circuit calculates a velocity of the aerosol particles on the basis of the signal.

Since the aerosol particles are irradiated with the irradiating light and the scattered light based on the aerosol particles is received, this makes it possible to accurately detect the position of the aerosol particles by a TOF (time-of-flight) analysis based on the direction of radiation of the irradiating light and the time until reception of the scattered light. Further, since the velocity of the aerosol particles is calculated, this also makes it possible, for example, to determine the type of the aerosol particles or estimate the range of diffusion of the aerosol particles. Thus, the aerosol analysis apparatus according to the present aspect makes it possible to detect the position of the aerosol particles with a high degree of accuracy and assist in determining the type of the aerosol particles.

Further, for example, in the aerosol analysis apparatus according to the aspect of the present disclosure, the photodetector may receive a first light that is generated in a case where a first space that is one of a plurality of unit spaces has been irradiated with the irradiating light and a second light that is generated in a case where a second space that is one of the plurality of unit spaces and that is different from the first space has been irradiated with the irradiating light, the photodetector may output a first signal corresponding to an intensity of the first light thus received and a second signal corresponding to an intensity of the second light thus received, and the signal processing circuit may determine, on the basis of the first signal and the second signal, a difference between a point in time at which the first light was received and a point in time at which the second light was received and a distance between the first space and the second space and calculate the velocity on the basis of the difference thus determined and the distance thus determined.

This makes it possible to quickly calculate the velocity of the aerosol particles by radiating the irradiating light at least twice.

Further, for example, in the aerosol analysis apparatus according to the aspect of the present disclosure, a controller may determine whether a person is present in a target space and, in a case where the controller has determined that a person is present, cause the irradiating light to be radiated toward either a unit space including a part of a head of the person or a unit space closest to the part of the head of the person and one or more unit spaces adjacent to the unit space.

This makes it possible to detect droplets just forced out of the mouth of the person and therefore makes the velocity that is calculated equal to the initial velocity of the droplets. This makes it possible to increase the accuracy of determination of the droplets by a comparison between the velocity and a threshold.

Further, an aerosol analysis method serving as an example of the scatterer measurement method according to the aspect of the present disclosure includes radiating irradiating light toward aerosol particles, receiving scattered light generated by the aerosol particles scattering the irradiating light, and calculating a velocity of the aerosol particles on the basis of a signal corresponding to an intensity of light received.

This makes it possible to detect the position of aerosol particles with a high degree of accuracy and assist in determining the type of the aerosol particles.

Incidentally, in general, an aerosol that may harm human health is present in a room. Examples of the aerosol include droplets containing a virus or bacteria, house dust, pollen, or PM_{2.5}. The incorporation into the body of the aerosol by contact or breathing poses a risk for developing an infectious disease, allergic rhinitis, or bronchial asthma.

Conventionally, there has been known an air cleaner containing a pollen sensor or a PM_{2.5} sensor. The air cleaner has a function of displaying an alert or a function of changing operation modes upon detection of pollen or PM_{2.5} in the air suctioned.

However, since the air cleaner carries out a measurement by suctioning air in the place where it has been installed, it cannot grasp what type of aerosol is distributed in the room or how the aerosol is distributed in the room. To address this problem, for example, Japanese Unexamined Patent Application Publication No. 2014-206291 and International Publication No. 2016/181854 disclose known terminal apparatuses for visualizing and displaying an aerosol.

However, the technologies described in Japanese Unexamined Patent Application Publication No. 2014-206291 and International Publication No. 2016/181854 are undesirably unable to accurately identify the position or type of aerosol particles.

To address this problem, an aerosol analysis method serving as an example of the scatterer measurement method according to the aspect of the present disclosure includes irradiating aerosol particles with polarized irradiating light, receiving scattered light generated by the aerosol particles scattering the irradiating light, making a first determination on the basis of a depolarization ratio of the scattered light thus received as to whether the aerosol particles are aspherical particles, and in a case where the aerosol particles have been identified as not being aspherical particles, making a second determination on the basis of a falling velocity of the aerosol particles as to whether the aerosol particles are PM_{2.5}.

Since the aerosol particles are irradiated with the irradiating light and the scattered light based on the aerosol particles is received, this makes it possible to calculate the position of the aerosol particles by a TOF analysis based on the direction of radiation of the irradiating light and the time until reception of the scattered light. Further, the depolarization ratio and the falling velocity can be used to determine whether the aerosol particles thus detected are aspherical particles such as house dust or PM_{2.5}. Thus, the aerosol analysis method according to the present aspect makes it possible to accurately identify the position and type of the aerosol particles.

Further, for example, in the aerosol analysis method according to the aspect of the present disclosure, the irradiating may include irradiating the aerosol particles with the irradiating light twice, the receiving may include receiving the scattered light twice, the second determination may include calculating the falling velocity on the basis of a distance in a vertical direction between a first position of the aerosol particles at a point of time at which the first irradiating light was scattered and a second position of the aerosol particles at a point of time at which the second irradiating light was scattered and a time interval between first reception of the scattered light and second reception of the scattered light.

This makes it possible to easily calculate the falling velocity by computation. Further, this does not require a dedicated configuration for obtaining the falling velocity and can therefore simplify the configuration of the aerosol analysis apparatus.

Further, for example, in the aerosol analysis method according to the aspect of the present disclosure, the irradiating may include, in a case where after the first irradiating light has been radiated toward a first space, the scattered light based on the irradiating light has been received, radiating the second irradiating light toward a second space located vertically below the first space.

This makes it easy for scattered light from a fallen scatterer to be received and therefore makes it possible to easily and accurately calculate the falling velocity. The increase in accuracy of calculation of the falling velocity can lead to an increase in accuracy of identification of the type of the aerosol particles.

Further, in one general aspect, the techniques disclosed here feature an aerosol analysis apparatus including: a light source that irradiates aerosol particles with irradiating light; a first polarizing filter that polarizes irradiating light radiated from the light source; a beam splitter that splits, into a first scattered light and a second scattered light, scattered light generated by the aerosol particles scattering irradiating light having passed through the first polarizing filter, a second polarizing filter, disposed on an optical path of the first scattered light, that transmits a polarization component parallel to a plane of polarization of the irradiating light; a first photosensitive element that receives the first scattered light having passed through the second polarizing filter; a third polarizing filter, disposed on an optical path of the second scattered light, that transmits a polarization component perpendicular to the plane of polarization of the irradiating light; a second photosensitive element that receives the second scattered light having passed through the third polarizing filter; and a signal processing circuit that acquires a depolarization ratio on the basis of an intensity of light received by the first photosensitive element and an intensity of light received by the second photosensitive element, wherein the signal processing circuit further determines, on the basis of the depolarization ratio, whether the aerosol particles are aspherical particles and, in a case where the aerosol particles have been identified as not being aspherical particles, determines, on the basis of a falling velocity of the aerosol particles, whether the aerosol particles are PM_{2.5}.

This makes it possible to calculate the position of the aerosol particles by a TOF analysis based on the direction of radiation of the irradiating light and the time until reception of the scattered light. Further, the depolarization ratio and the falling velocity can be used to determine whether the aerosol particles thus detected are aspherical particles such as house dust or PM_{2.5}. At this point in time, the depolarization ratio can be easily calculated by using two polarizing filters that transmit polarization components orthogonal to each other and two photosensitive elements. Thus, the aerosol analysis apparatus according to the present aspect makes it possible to accurately identify the position and type of the aerosol particles.

In the present disclosure, all or some of the circuits, units, devices, members, or sections or all or some of the functional blocks in the block diagrams may be implemented as one or more of electronic circuits including, but not limited to, a semiconductor device, a semiconductor integrated circuit (IC), or an LSI (large scale integration). The LSI or IC can be integrated into one chip, or also can be a combination of multiple chips. For example, functional blocks other than a memory may be integrated into one chip. The name used here is LSI or IC, but it may also be called system LSI, VLSI (very large scale integration), or ULSI (ultra large scale integration) depending on the degree of integration. An FPGA (Field Programmable Gate Array) that can be programmed after manufacturing an LSI or a reconfigurable logic device that allows reconfiguration of the connection or setup of circuit cells inside the LSI can be used for the same purpose.

Further, it is also possible that all or some of the functions or operations of the circuits, units, devices, members, or sections are implemented by executing software. In such a case, the software is recorded on one or more non-transitory recording media such as a ROM, an optical disk, or a hard disk drive, and when the software is executed by a processor, the software causes the processor together with peripheral devices to execute the functions specified in the software. A system or device may include such one or more non-transitory recording media on which the software is recorded and a processor together with necessary hardware devices such as an interface.

In the following, embodiments are specifically described with reference to the drawings.

It should be noted that the embodiments to be described below each illustrate a comprehensive and specific example of the present disclosure. The numerical values, shapes, materials, constituent elements, placement and topology of constituent elements, steps, orders of steps, and the like that are shown in the following embodiments are merely examples and are not intended to limit the present disclosure. Further, those of the constituent elements in the following embodiments which are not recited in an independent claim are described as optional constituent elements.

Further, the drawings are schematic views and are not necessarily strict illustrations. Accordingly, for example, the drawings are not necessarily to scale. Further, in the drawings, substantially the same components are given the same reference signs, and a repeated description may be omitted or simplified.

Further, terms such as “parallel” and “perpendicular” used herein to show the way in which elements are interrelated, terms such as “cubic” used herein to show the shape of an element, and ranges of numerical values used herein are not expressions that represent only exact meanings but expressions that are meant to also encompass substantially equivalent ranges, e.g. differences of approximately several percent.

### Embodiment 1

### 1. Brief Overview

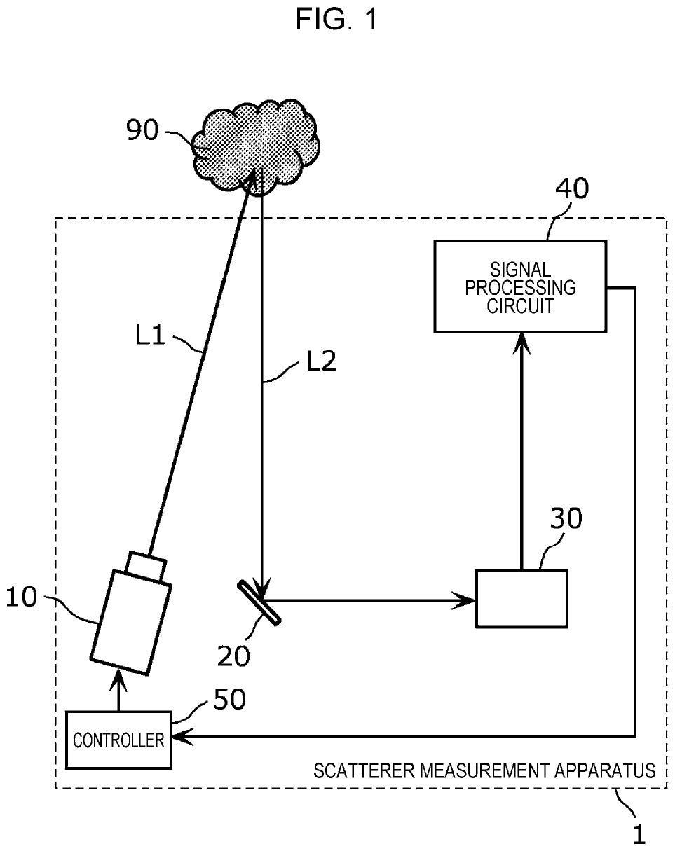

First, a brief overview of a scatterer measurement apparatus according to Embodiment 1 is given with reference to FIG. 1. FIG. 1 is a diagram showing a configuration of a scatterer measurement apparatus according to the present embodiment.

A scatterer measurement apparatus 1 according to the present embodiment radiates irradiating light L1, acquires scattered light L2 generated by scattering of the irradiating light L1 by aerosol particles 90 present in a space, processes the scattered light L2 thus acquired, and thereby determines the presence or absence, position, type, and concentration of the aerosol particles 90. The aerosol particles 90 are an example of a scatterer that scatters the irradiating light L1. The space in which the aerosol particles 90 are present is an irradiated space that is irradiated with the irradiating light L1, and is a part of a target space to be measured by the scatterer measurement apparatus 1.

Specifically, the scatterer measurement apparatus 1 irradiates a first space in which the aerosol particles 90 are present with the irradiating light L1 as a first irradiating light and, after a predetermined period of time has elapsed, irradiates a second space in which the aerosol particles 90 are present with the irradiating light L1 as a second irradiating light. The scatterer measurement apparatus 1 calculates the moving velocity of the aerosol particles 90 on the basis of the difference between a first point in time at which scattered light L2 corresponding to the first irradiating light was received as a first scattered light and a second point in time at which scattered light L2 corresponding to the second irradiating light was received as a second scattered light and the distance that the aerosol particles 90 moved during a period from the first point in time to the second point in time. For example, the scatterer measurement apparatus 1 determines, on the basis of the moving velocity thus calculated, whether the aerosol particles 90 are droplets.

As shown in FIG. 1, the scatterer measurement apparatus 1 includes a light source 10, a mirror 20, a photodetector 30, a signal processing circuit 40, and a controller 50.

The light source 10 radiates irradiating light L1 that passes through a space in which aerosol particles 90 are present. The irradiating light L1 may for example be pulsed light, but may be continuous light. The irradiating light L1 may be monochromatic light having a peak in a particular band of wavelengths, or may be light including a broad band of wavelengths. An example of the irradiating light L1 is ultraviolet light, blue light, white light, or infrared light.

The light source 10 is for example a semiconductor laser element that emits laser light as the irradiating light L1. Alternatively, the light source 10 may be an LED (light-emitting diode), or may be a discharge lamp such as a halogen lamp.

The irradiating light L1 is scattered by the aerosol particles 90, and a portion of the irradiating light L1 thus scattered returns to the scatterer measurement apparatus 1 as scattered light L2. The scattered light L2 is backscattered light that is generated by the aerosol particles 90 scattering the irradiating light L1. The scattered light L2 is light based on Mie scattering effected by the aerosol particles 90.

The mirror 20 reflects the scattered light L2. Placing the mirror 20 at an appropriate angle with respect to the scattered light L2 makes it possible to bend the scattered light L2 so that the scattered light L2 travels in a desired direction.

The photodetector 30 receives the scattered light L2 and outputs a signal corresponding to the intensity of light received. The intensity of light received is the intensity of the scattered light L2 and, for example, is expressed by the signal level of the signal that the photodetector 30 outputs.

The photodetector 30 is a photoelectric conversion element and, for example, is a PMT (photomultiplier tube). Alternatively, the photodetector 30 may have a PMT and a photon counter. Alternatively, the photodetector 30 may be an avalanche photodiode (APD).

The signal processing circuit 40 calculates the velocity of the aerosol particles 90 on the basis of the signal that is outputted from the photodetector 30. In the present embodiment, the signal processing circuit 40 further compares the velocity thus calculated with a threshold. In a case where the velocity thus calculated is greater than or equal to the threshold, the signal processing circuit 40 identifies the aerosol particles 90 as droplets forced out of the mouth of a person. In a case where the velocity thus calculated is less than the threshold, the signal processing circuit 40 identifies the aerosol particles 90 as not being droplets. For example, in a case where the velocity thus calculated is less than the threshold, the signal processing circuit 40 may identify the aerosol particles 90 as pollen or PM_{2.5}.

Droplets are a type of aerosol particle. Droplets are forced out of the mouth of a person. Droplets are microdroplets that are dynamically generated by a person coughing, sneezing, or uttering. Droplets may contain a virus, bacteria, or other substances. Since droplets are generated by a person's action, they have a high initial velocity at a point of time at which they are generated.

In general, aerosol particles include not only droplets but also house dust such as grit and dust, yellow sand, air-polluting aerosols, suspended particulate matter such as PM_{2.5}, and bioparticles such as pollen, or other particles. Aerosol particles other than droplets are usually suspended in air at a sufficiently lower velocity than droplets.

The threshold for determination of droplets is a value that is lower than the initial velocity of droplets forced out of the mouth of a person having coughed or sneezed. The initial velocity of droplets that an ordinary person sneezes or coughs is approximately 8 m/s in a horizontal direction. The velocity of droplets in a horizontal direction becomes lower away from the mouth. In the present embodiment, which takes into account the incapability of detecting the aerosol particles 90 in the immediate vicinity of the mouth, the threshold is for example 5 m/s.

The threshold may be smaller than 5 m/s. In this case, the threshold is for example a value that is larger than the moving velocity of aerosol particles other than droplets in a horizontal direction. In a room without wind, aerosol particles other than droplets move into an air current that is generated mainly on the basis of a person's movement. The walking speed of a person is in general lower than 2 m/s. For this reason, the threshold may for example be greater than or equal to 2 m/s.

Further, in a case where a current of air is produced by an air conditioner or other devices in the space in which the aerosol particles 90 are present, the threshold may be a value greater than the air velocity and lower than the initial velocity of droplets.

Further, the signal processing circuit 40 calculates the distance to the aerosol particles 90 by a TOF analysis on the basis of the time required to receive the scattered light L2 since the irradiating light L1 was radiated. Furthermore, the signal processing circuit 40 identifies the position of the aerosol particles 90 on the basis of the distance thus calculated and the direction in which the irradiating light L1 was radiated. By repeating identification of the position of the aerosol particles 90 while changing the direction of radiation of the irradiating light L1, the signal processing circuit 40 creates a distribution of the aerosol particles 90 within the target space.

The signal processing circuit 40 is constituted by one or more electronic circuits including a plurality of circuit components. The one or more electronic circuits may each be a general-purpose circuit or may each be a dedicated circuit. That is, a function that the signal processing circuit 40 executes is implemented as hardware such as an electronic circuit. Alternatively, the signal processing circuit 40 may be implemented as, for example, a nonvolatile memory in which a program is stored, a volatile memory serving as a transitory storage area in which to execute a program, an I/O port, or a processor that executes a program. The function that the signal processing circuit 40 executes may be implemented as software that is executed by a processor.

The controller 50 controls the light source 10. Specifically, the controller 50 changes the direction of radiation of the irradiating light L1. The direction of radiation of the irradiating light L1 is changed, for example, by a MEMS (microelectromechanical system) mirror (not illustrated). In the present embodiment, the target space in which the aerosol particles 90 are present is virtually divided into a plurality of unit spaces each having a predetermined shape. The sizes of the predetermined shapes of the unit spaces can be defined by, for example, the distance that the irradiating light L1 travels per unit time and the distance that the light source 10 scans or the distance that the irradiating light L1 travels per unit time and the range over which the photodetector 30 can receive light. Accordingly, the sizes of the unit spaces can vary according to the unit time. By controlling the light source 10, the controller 50 causes the light source 10 to radiate the irradiating light L1 toward each of the plurality of unit spaces. A specific operation will be described later.

The controller 50 is constituted by one or more electronic circuits including a plurality of circuit components. The one or more electronic circuits may each be a general-purpose circuit or may each be a dedicated circuit. That is, a function that the controller 50 executes is implemented as hardware such as an electronic circuit. Alternatively, the controller 50 may be implemented as, for example, a nonvolatile memory in which a program is stored, a volatile memory serving as a transitory storage area in which to execute a program, an I/O port, or a processor that executes a program. The function that the controller 50 executes may be implemented as software that is executed by a processor. The controller 50 and the signal processing circuit 40 may share hardware resources such as memories.

The constituent elements of the scatterer measurement apparatus 1 are housed, for example, in a housing (not illustrated). The housing is the outer-shell housing of the scatterer measurement apparatus 1, and has a light blocking effect. The housing is provided with an opening through which the irradiating light L1 and the scattered light L2 are allowed to pass. These openings may be provided one by one separately in correspondence with the irradiating light L1 and the scattered light L2.

Further, the scatterer measurement apparatus 1 may include a condenser that concentrates the scattered light L2. For example, a condensing lens, i.e. an example of the condenser, may be provided in the opening through which the scattered light L2 passes. The condensing lens may be provided in the housing. For example, the condensing lens may be provided between the opening through which the scattered light L2 passes and the mirror 20, or may be provided between the mirror 20 and the photodetector 30. A collector mirror may be provided instead of the condensing lens.

### 2. Detection of Aerosol Particles

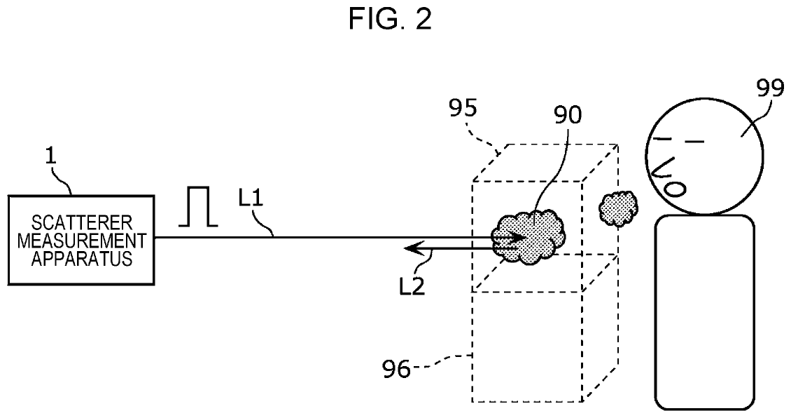

The following describes a method for detecting aerosol particles 90 with the scatterer measurement apparatus 1. First, a method for detecting the position of aerosol particles 90 is described with reference to FIG. 2. FIG. 2 is a diagram schematically showing how aerosol particles 90 are detected by the scatterer measurement apparatus 1 according to the present embodiment.

As shown in FIG. 2, the scatterer measurement apparatus 1 radiates irradiating light L1 toward a predetermined position in the target space. Specifically, the scatterer measurement apparatus 1 radiates irradiating light L1 that passes through a first space that is a part of the target space. In a case where aerosol particles 90 are present in the position toward which the irradiating light L1 was radiated or, specifically, in the first space, the irradiated light L1 is scattered by the aerosol particles 90, so that scattered light L2 is generated. The scatterer measurement apparatus 1 acquires the scattered light L2 and identifies the position of the aerosol particles 90 on the basis of the scattered light L2 thus acquired.

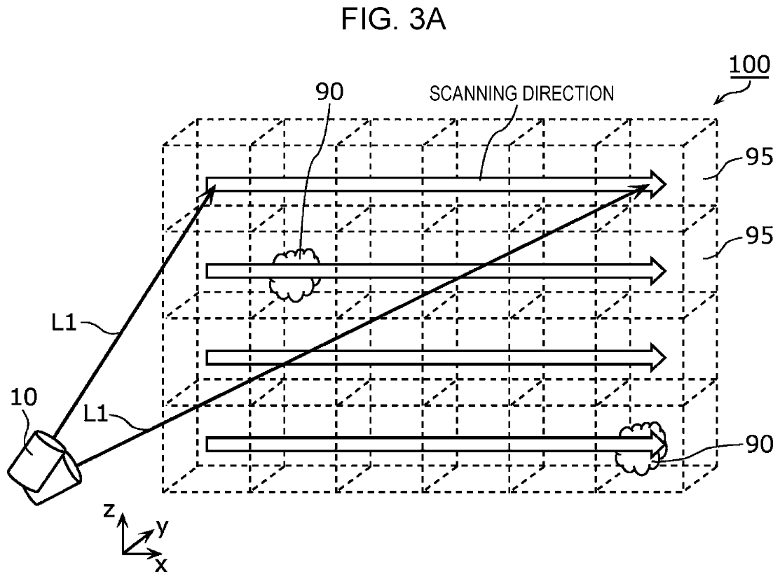

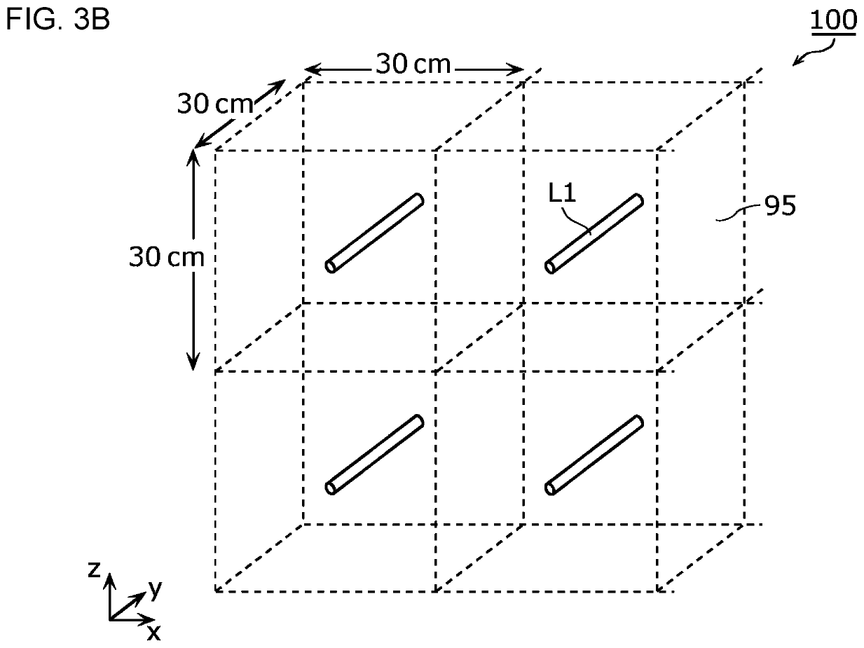

The target space is described here with reference to FIG. 3A. FIG. 3A is a diagram showing an example of the target space. As shown in FIG. 3A, a target space 100 is a space to be measured by the scatterer measurement apparatus 1. FIG. 3A shows an x axis, a y axis, and a z axis that are orthogonal to one another.

The target space 100 is a room in a building such as a house, an office, a nursing facility, or a hospital. The target space 100 is, but is not limited to, an enclosed space partitioned by, for example, a wall, a window, a door, a floor, and a ceiling. For example, the target space 100 may be an outdoor open space. Alternatively, the target space 100 may be an interior space in a movable body such as a bus or an airplane.

Usually, in consideration of a situation in which a scatterer moves, a space that is equal to a moving range of the scatterer or a space that is wider than the moving range of the scatterer is set as the target space 100.

As shown in FIG. 3A, the scatterer measurement apparatus 1 according to the present embodiment passes the irradiating light L1 over the target space 100 in all directions of radiation. In the case of the example shown in FIG. 3A, a scan is done from the upper left to the upper right, and in a one-down position, a scan is done from the left to the right. By repeating these scans, the whole target space is scanned. FIG. 3A uses outline arrows to indicate scanning directions.

As shown in FIG. 3A, the target space 100 is virtually divided into a plurality of unit spaces 95 each having a predetermined shape. As one example, divided unit spaces are described in detail with reference to FIG. 3B. FIG. 3B is a diagram showing examples of unit spaces obtained by virtually dividing the target space. Specifically, FIG. 3B shows the upper left four unit spaces of FIG. 3A. Each of the unit spaces 95 has, for example, a cubic shape with a length of 30 cm on a side.

As one example, the irradiating light L1 is laser light with a diameter of 5 mm. For example, the laser light passes through the center of gravity of each of the unit spaces 95. The laser light is radiated at a cycle of 1 μs, and has a pulse duration of 2 ns. As one example, the target space 100 has a size of roughly 10 m×10 m×10 m.

Suppose here that a measurement of the velocity of a scatterer is carried out by scanning the target space 100 in a second. Suppose first that an x-z plane measuring 10 m×10 m in FIG. 3A is scanned.

Assuming that the size of the x-z plane of one unit space 95 in FIG. 3B is 30 cm×30 cm, the number of spots of laser light that is passed over 10 m×10 m is given as 33 points×33 points=1089 points. For example, since a measurement is carried out by performing 1000 rounds of irradiation of 1 μs at one point, the duration of a measurement at one point is 1 ms. Measured values thus obtained are averaged to give a measured value of one unit space 95.

Measurements carried out at all of the 1089 points take a total of approximately one second given as 1 ms×1089 points. That is, the area of 10 m×10 m can be measured in approximately one second.

Meanwhile, assuming that a measurement can be done up to a depth of 10 m, a resolving power over a depth distance is 30 cm, as the duration of a pulse at one point is 2 ns. Therefore, a measurement in unit spaces 95 worth of 33×33×33=35937 points of measurement in the target space 100 with an area of 10 m×10 m×10 m can be carried out in approximately one second.

In the present disclosure, which takes into account a situation in which a scatterer moves, a space that is equal to a moving range of the scatterer or a space that is wider than the moving range of the scatterer is set as the target space 100. The size of a unit space 95 is determined so that a motion of the scatterer can be extracted from the target space 100 thus set, and the target space 100 is virtually divided into unit spaces 95 of the size thus determined. This makes it possible to capture a motion of the scatterer with a high degree of accuracy all over the target space 100 and measure the velocity of the scatterer at a high speed. The photodetector 30 needs only be able to receive scattered light from a scatterer contained in a unit space 95.

The scatterer measurement apparatus 1 irradiates each unit space 95 with the irradiating light L1. The direction of radiation may be continuously changed, or may be discretely changed. For example, continuous light or pulsed light may be radiated as irradiating light while sequentially changing its direction of radiation.

FIG. 2 shows two unit spaces 95 and 96. In the unit space 95, droplets forced out of a person 99 are present as the aerosol particles 90. In a case where the unit space 95 is irradiated with the irradiating light L1, the scattered light L2 is generated by the aerosol particles 90 scattering the irradiating light L1.

The shape of a unit space is not limited to a cubic shape but may be a cuboidal shape. Alternatively, the shape of a unit space may be a spherical shape. Two adjacent unit spaces may be in contact with each other, may partially overlap each other, or may be separated from each other. The length of a side of a unit space is 0.3 m (30 cm) in a case where the unit space has a cubic shape. The longer the length of a side of a unit space is, the higher the signal strength of scattered light that is received becomes. Therefore, the length of a side of a unit space may be determined so that the signal strength of scattered light that is received can be sensed.

The signal processing circuit 40 calculates the position of generation of scattered light L2, i.e. the distance to the unit space 95 containing the aerosol particles 90, by a TOF analysis. In the present embodiment, as shown in FIG. 2, the irradiating light L1 is pulsed light; therefore, the time until reception of the scattered light L2 based on the irradiating light L1 radiated can be easily determined. The signal processing circuit 40 calculates, on the basis of the time from radiation of the irradiating light L1 to reception of the scattered light L2, the distance to a unit space containing the aerosol particles 90 by which the scattered light L2 was generated.

### 3. Calculation of Moving Velocity of Aerosol Particles

The following describes a method for calculating the moving velocity of aerosol particles 90 that is used for determining whether the aerosol particles 90 are droplets.

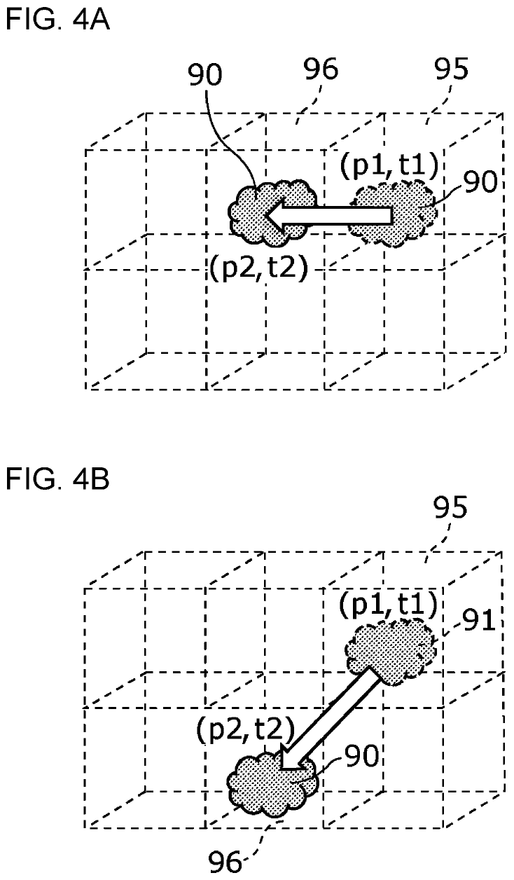

FIGS. 4A and 4B are each a diagram for explaining a method for calculating the velocity of aerosol particles with the scatterer measurement apparatus 1 according to the present embodiment. FIGS. 4A and 4B show cases where aerosol particles 90 have moved from a unit space 95 to a unit space 96. In FIG. 4A, the unit space 95 and the unit space 96 are adjacent to each other in a horizontal direction while sharing one surface with each other. In FIG. 4B, the unit space 95 and the unit space 96 are adjacent diagonally to each other while sharing one side with each other.

The unit space 95 is an example of a first space that is one of the plurality of unit spaces. The unit space 96 is one of the plurality of unit spaces, and is an example of a second space that is different from the first space. In a case where the aerosol particles 90 are present in the unit space 95, irradiation of the unit space 95 with the irradiating light L1 as the first irradiating light causes the scattered light L2 to be generated as the first scattered light in the unit space 95. In a case where the aerosol particles 90 are present in the unit space 96, irradiation of the unit space 96 with the irradiating light L1 as the second irradiating light causes the scattered light L2 to be generated as the second scattered light in the unit space 96.

In the present embodiment, by controlling the light source 10, the controller 50 causes the light source 10 to irradiate the unit space 95 and the unit space 96 with the irradiating light L1 at different timings. The photodetector 30 receives the first scattered light generated in the unit space 95 and outputs a first signal corresponding to the intensity of the first scattered light thus received. Further, the photodetector 30 receives the second scattered light generated in the unit space 96 and outputs a second signal corresponding to the intensity of the second scattered light thus received.

The signal processing circuit 40 determines, on the basis of the first signal and the second signal, the difference between a first point in time at which the first scattered light was received and a second point in time at which the second scattered light was received and the distance that the aerosol particles 90 moved during a period from the first point in time to the second point in time. The distance that the aerosol particles 90 moved during the period from the first point in time to the second point in time can be deemed to be identical to the distance between the unit space 95 and the unit space 96. The signal processing circuit 40 calculates the velocity of the aerosol particles 90 on the basis of the difference thus determined and the distance thus determined. Specifically, the signal processing circuit 40 calculates the velocity v of the aerosol particles 90 on the basis of Formula (1) as follows:

$$v = \frac{\vert {p}_{i + 1} - {p}_{i} \vert}{{t}_{i + 1} - {t}_{i}} \qquad ( 1 )$$

where pᵢ is the position of the first space, e.g. p₁, which is the position of the space unit 95, pᵢ₊₁ is the position of the second space, e.g. p₂, which is the position of the space unit 96, t₁ is the point in time at which the first scattered light was received, e.g. t₁, which is the first point in time at which the scattered light from the unit space 95 was received, and tᵢ₊₁ is the point in time at which the second scattered light was received, e.g. t₂, which is the second point in time at which the scattered light from the unit space 96 was received.

The position p₁ of the unit space 95 and the position p₂ of the unit space 96 are both coordinates for three-dimensional positions in the target space. Specifically, p₁ and p₂ each indicate the center position of a unit space.

For example, the position pᵢ of the unit space 95 can be expressed as (x₁, y₁, z₁) in a three-dimensional orthogonal coordinate system whose three axes are an x axis, a y axis, and a z-axis. Similarly, the position p₂ of the unit space 96 can be expressed as (x₂, y₂, z₂). For example, the x-y plane represents a horizontal surface, and the z axis represents a vertical direction.

In the example shown in FIG. 4A, the unit space 95 and the unit space 96 are adjacent to each other in a horizontal direction. For this reason, the distance between the unit space 95 and the unit space 96 is the length of a side of a unit space. That is, the distance that the aerosol particles 90 moved during the period from the point in time t1 to the point in time t2 is expressed as the length of a side of a unit space.

In the example shown in FIG. 4B, the unit space 95 and the unit space 96 are adjacent diagonally to each other. For this reason, the distance between the unit space 95 and the unit space 96 is the length of a diagonal of a unit space. That is, the distance that the aerosol particles 90 moved during the period from the point in time t1 to the point in time t2 is expressed as the length of a diagonal of a unit space.

FIGS. 4A and 4B assume that all unit spaces have the same shape and size. In the case of unit spaces having different shapes and sizes, the distance that the aerosol particles 90 moved can be obtained by calculating the distance between the center position of each unit space and the center position of the other unit space. In each of the cases of FIGS. 4A and 4B, the velocity v of the aerosol particles 90 can be calculated according to Formula (1) on the basis of the difference between the point in time at which the scattered light from the unit space 95 was received and the point in time at which the scattered light from the unit space 96 was received.

### 4. Operation

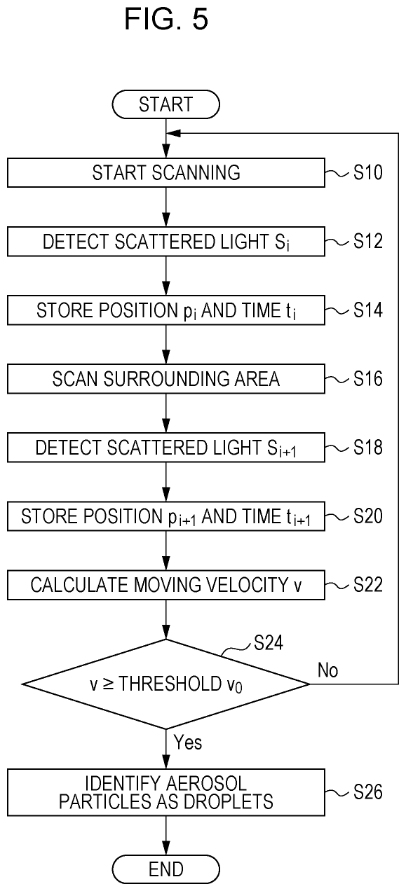

The following describes an operation of the scatterer measurement apparatus 1 according to the present embodiment with reference to FIG. 5. FIG. 5 is a flow chart showing an operation of the scatterer measurement apparatus 1 according to the present embodiment.

As shown in FIG. 5, first, the scatterer measurement apparatus 1 starts scanning of the target space (S10). Specifically, the controller 50 irradiates each unit space with the irradiating light L1. For example, the controller 50 radiates the irradiating light L1 toward one of the plurality of unit spaces and, in a case where no scattered light L2 is received by the photodetector 30, radiates the irradiating light L1 toward another unit space.

Next, the photodetector 30 detects scattered light Sᵢ (S12). The scattered light Sᵢ means the ith scattered light L2 obtained by radiating the irradiating light L1. i is a natural number. The photodetector 30 outputs a first signal corresponding to the intensity of the scattered light Sᵢ.

Next, on the basis of the first signal, the signal processing circuit 40 stores, in a memory, the position pᵢ of a unit space in which aerosol particles 90 from which the scattered light Sᵢ thus detected originates are present, i.e. a unit space irradiated with the irradiating light L1, and the point in time tᵢ at which the scattered light Sᵢ was received (S14). The position p₁ may be calculated, for example, by a TOF analysis.

Next, by controlling the light source 10, the controller 50 scans an area around the unit space in which the scattered light Sᵢ was generated (S16). For example, in a case where the scattered light L2 from the unit space 95 shown in FIG. 2 has been received as the scattered light Sᵢ, the controller 50 causes the light source 10 to radiate the irradiating light L1 that so that the irradiating light L1 passes through the unit space 96 adjacent to the unit space 95. In this way, a search is made for a place to which the aerosol particles 90 present in the unit space 95 move.

It is assumed that a person 99 coughs or sneezes droplets in all directions. As shown in FIG. 4A, droplets forced out in a horizontal direction move to the unit space 96 adjacent to the unit space 95 in a horizontal direction. Alternatively, as shown in FIG. 4B, droplets forced out diagonally downward move to the unit space 96 adjacent diagonally downward to the unit space 95. Although not illustrated, droplets may be forced out directly downward, or depending on the posture of the person 99, droplets may be forced out directly upward.

For this reason, in the present embodiment, upon detection of the aerosol particles 90, the controller 50 causes the irradiating light L1 to be radiated toward one or more unit spaces adjacent to the unit space in which the aerosol particles 90 have been detected. In a case where it is possible to identify the position and orientation of the face of the person 99, the controller 50 may preferentially radiate the irradiating light L1 toward a unit space located in front of the face.

Next, the photodetector 30 detects scattered light Sᵢ₊₁ (S18) and outputs a second signal corresponding to the intensity of the scattered light Sᵢ₊₁. On the basis of the second signal, the signal processing circuit 40 stores, in the memory, the position pᵢ₊₁ of a unit space in which the aerosol particles 90 from which the scattered light Sᵢ₊₁ thus detected originates are present and the point in time tᵢ₊₁ at which the scattered light Sᵢ₊₁ was received (S20).

Next, on the basis of the position pᵢ, the point in time tᵢ, the position pᵢ₊₁, and the point in time tᵢ₊₁ stored in the memory, the signal processing circuit 40 calculates the velocity v of the aerosol particles 90 according to Formula (1) (S22). Next, the signal processing circuit 40 compares the velocity v thus calculated with a threshold v₀ (S24). In a case where the velocity v thus calculated is greater than or equal to the threshold v₀ (Yes in S24), the signal processing circuit 40 identifies the aerosol particles 90 as droplets (S26). In a case where the velocity v thus calculated is less than the threshold v₀ (No in S24), the signal processing circuit 40 identifies the aerosol particles 90 as not being droplets, and returns to step S10 to repeat the scanning of the target space.

As noted above, the present embodiment makes it possible to, by comparing the velocity v of the aerosol particles 90 with the threshold v₀, determine whether the aerosol particles 90 are droplets. For this reason, an area in the target space where droplets are present can be detected by changing the direction of radiation of the irradiating light L1 for each unit space. This makes it possible to accurately identify the range and direction of diffusion of the droplets, thus making it possible, for example, to create a droplet distribution map and present it to a user. Further, since the position of the droplets is identified, it is also possible to effectively remove a virus contained in the droplets by appropriately supplying a purifying substance such as hypochlorous acid toward the droplets.

### Embodiment 2

The following describes Embodiment 2.

Embodiment 1, which assumes a case where the irradiating light L1 reaches a unit space to be irradiated, is useful in a case where there are few obstacles in the target space. Meanwhile, in a case where there are many obstacles, the irradiating light L1 may fail to reach the unit space to be irradiated. Embodiment 2 illustrates a process that is performed in a case where there is an obstacle in the target space. In the following, a description is given with a focus on points of difference from Embodiment 1, and a description of common features is omitted or simplified.

### 1. Configuration

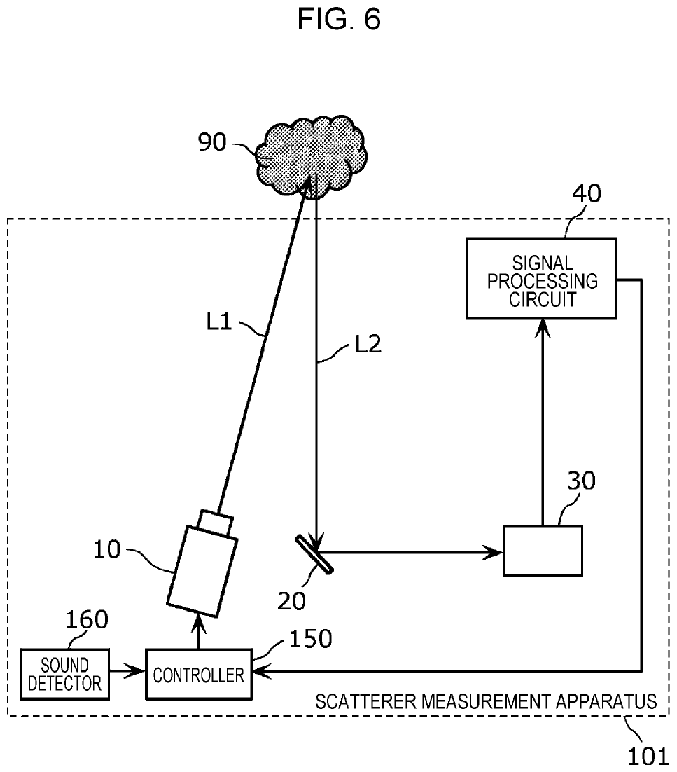

FIG. 6 is a diagram schematically showing an example of a configuration of a scatterer measurement apparatus 101 according to the present embodiment. As shown in FIG. 6, the scatterer measurement apparatus 101 according to the present embodiment differs from the scatterer measurement apparatus 1 according to Embodiment 1 in that the scatterer measurement apparatus 101 includes a controller 150 instead of the controller 50 and further includes a sound detector 160.

For example, the sound detector 160 detects a voice that a person 99 produces when he/she coughs or sneezes, and identifies the source of the voice, i.e. the position of the mouth of the person 99. The sound detector 160 is for example a microphone having directivity in a plurality of directions, and detects the position of the source of a sound. The sound detector 160 outputs, to the controller 150, positional information indicating the position of the source of a sound.

The controller 150 determines whether a person 99 is present in the target space. In a case where the controller 150 has determined that a person 99 is present, the controller 150 causes the irradiating light L1 to be radiated toward either a unit space including the mouth of the person 99 or a unit space closest to the mouth of the person 99 and one or more unit spaces adjacent to the unit space. For example, in a case where the sound detector 160 has successfully detected a voice produced at the same time as a cough or a sneeze, the controller 150 determines that a person 99 is present. That is, in a case where the controller 150 has acquired positional information outputted from the sound detector 160, the controller 150 determines that a person 99 is present.

The controller 150 acquires positional information that is outputted from the sound detector 160, and controls the light source 10 on the basis of the positional information thus acquired. Specifically, the controller 150 radiates the irradiating light L1 toward a unit space including the position indicated by the positional information and one or more unit spaces adjacent to the unit space. The unit space including the position indicated by the positional information is either a unit space including the mouth of the person 99 or a unit space closest to the mouth of the person 99.

Further, in a case where the controller 150 has radiated the irradiating light L1 toward a unit space, the controller 150 controls the light source 10 on the basis of a result of a comparison between the intensity of light received by the photodetector 30 and a threshold. Specifically, in a case where the intensity of light received by the photodetector 30 is greater than the threshold, the controller 150 radiates the irradiating light L1 toward a unit space around the unit space in which the received light whose intensity is greater than the threshold was generated. In a case where the intensity of light received by the photodetector 30 is less than or equal to the threshold, the controller 150 performs a process for determining whether aerosol particles 90 are droplets, as in the case of Embodiment 1.

The threshold is for example a value greater than the maximum possible intensity of scattered light L2 and less than or equal to the intensity of the irradiating light L1. For example, the threshold is set so that the intensity of light reflected off an obstacle reflecting the irradiating light L1 striking the obstacle and received by the photodetector 30 is greater than the threshold.

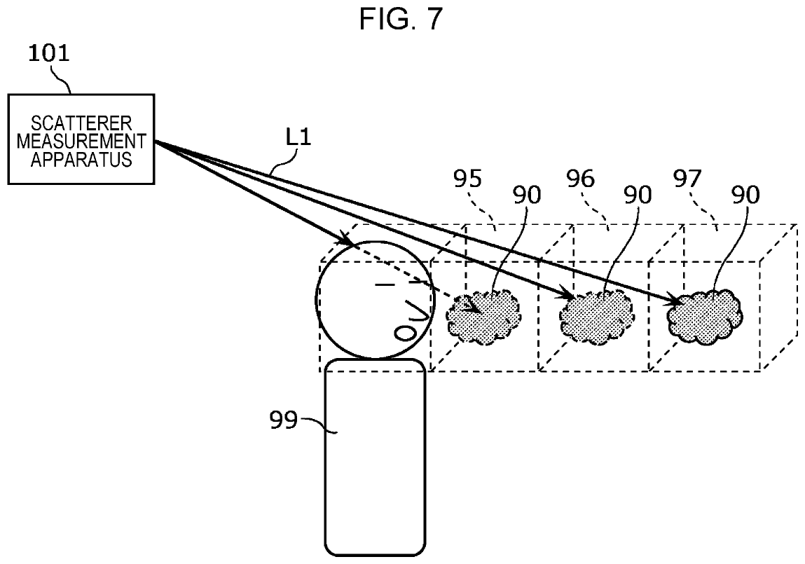

FIG. 7 is a diagram schematically showing how aerosol particles 90 are detected by the scatterer measurement apparatus 101 according to the present embodiment. As shown in FIG. 7, depending on a positional relationship between the scatterer measurement apparatus 101 and a person 99, the irradiating light L1 strikes the person 99 even when the irradiating light L1 is radiated toward a unit space 95, so that the scatterer measurement apparatus 101 cannot acquire scattered light L2 that is generated by the aerosol particles 90. Instead of acquiring scattered light L2, the scatterer measurement apparatus 101 acquires reflected light reflected by the person 99.

An obstacle such as the person 99 reflects intense light, as it is sufficiently larger than the aerosol particles 90. For example, there is an approximately six-digit difference in relative intensity ratio between reflected light from the person 99 and scattered light from the aerosol particles 90. For this reason, as mentioned above, whether light received by the photodetector 30 is scattered light from the aerosol particles 90 or reflected light from an obstacle can be determined by comparing the intensity of the light received with the threshold.

When the photodetector 30 has failed to receive scattered light L2 in a case where the controller 150 has radiated the irradiating light L1 toward the unit space 95, the controller 150 emits the irradiating light L1 to a unit space 96 and a unit space 97 that are located around the unit space 95. As a result, even when the scatterer measurement apparatus 101 has failed to detect the aerosol particles 90 in the unit space 95 closest to the mouth of the person 99, the scatterer measurement apparatus 101 can detect the aerosol particles 90 in the unit space 96 or 97 at a timing when the aerosol particles 90 have moved to the unit space, and can calculate the velocity of the aerosol particles 90.

In a case where the target space is an indoor space, a wall, a floor, a ceiling, a beam, a pillar, furniture, or other objects are present as obstacles other than the person 99. Since these obstacles are usually motionless, a unit space including an obstacle and the intensity of reflected light from the obstacle can be detected by scanning inside of the target space. For example, the scatterer measurement apparatus 101 includes a memory (not illustrated) in which a unit space including an obstacle detected and the intensity of reflected light detected are stored in association with each other.

This allows the scatterer measurement apparatus 101 to, in a case where high-intensity light has been detected from a unit space that does not match the information stored in the memory, determine that a part of the person 99 is present in the unit space. Further, a plurality of unit spaces in which a part of the person 99 can be determined to be present have been successively detected heightwise, the scatterer measurement apparatus 101 can determine the highest one of the plurality of unit spaces as the position of the head of the person 99.

### 2. Operation

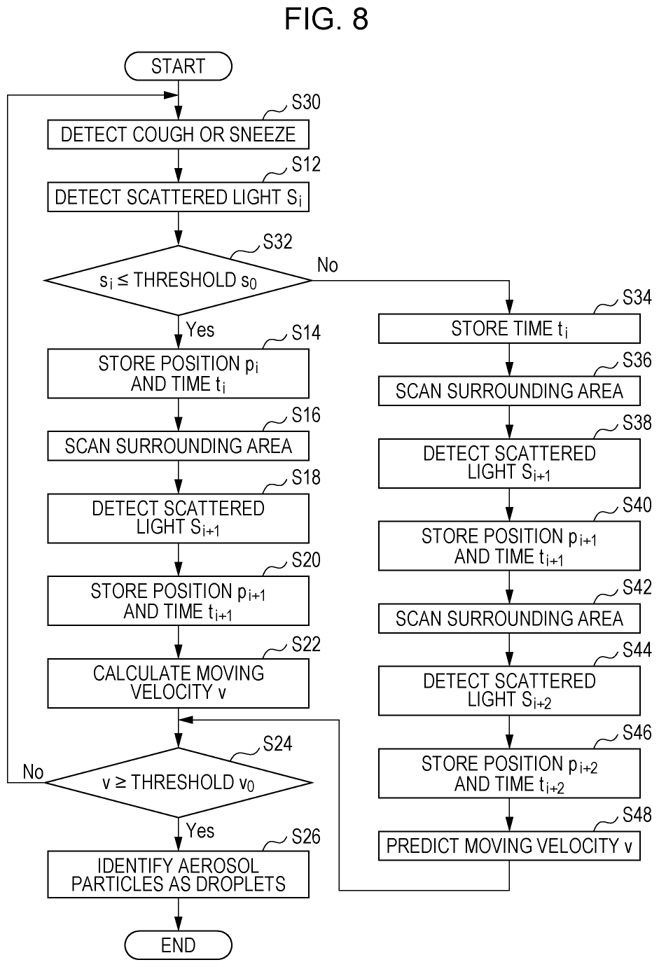

The following describes an operation of the scatterer measurement apparatus 101 according to the present embodiment with reference to FIG. 8. FIG. 8 is a flow chart showing an operation of the scatterer measurement apparatus 101 according to the present embodiment.

As shown in FIG. 8, first, the sound detector 160 detects a person 99 coughing or sneezing (S30). By controlling the light source 10, the controller 150 causes the light source 10 to radiate the irradiating light L1 toward the unit space in which the cough or the sneeze has occurred. As a result, the photodetector 30 detects scattered light Sᵢ and outputs a signal corresponding to the intensity sᵢ of the scattered light Sᵢ (S12).

The signal processing circuit 40 compares the intensity sᵢ of the scattered light Sᵢ with a threshold s₀ (S32). In a case where the intensity sᵢ of the scattered light Sᵢ is less than or equal to the threshold s₀ (Yes in S32), the signal processing circuit 40 stores, in the memory, the position pᵢ of a unit space in which aerosol particles 90 from which the scattered light Sᵢ thus detected originates are present and the point in time tᵢ at which the scattered light Sᵢ was received (S14). After this, as in the case of Embodiment 1, the scatterer measurement apparatus 101 performs a process from step S16 to step S26 to determine whether the aerosol particles 90 are droplets.

In a case where the intensity sᵢ of the scattered light Sᵢ is greater than the threshold s₀ (No in S32), the signal processing circuit 40 stores, in the memory, the point in time tᵢ at which the scattered light Sᵢ was received (S34). Next, by controlling the light source 10, the controller 150 scans an area around the unit space in which the scattered light Sᵢ was generated (S36). For example, in a case where the intensity si of scattered light from the unit space 95 shown in FIG. 7 is greater than the threshold s₀, the controller 150 causes the light source 10 to radiate the irradiating light L1 toward the unit space 96 adjacent to the unit space 95. In this way, a search is made for a place to which the aerosol particles 90, which were not successfully detected in the unit space 95, move.

Next, the photodetector 30 detects scattered light Sᵢ₊₁ (S38) and outputs a first signal corresponding to the intensity sᵢ₊₁ of the scattered light Sᵢ₊₁. On the basis of the first signal, the signal processing circuit 40 stores, in the memory, the position pᵢ₊₁ of a unit space in which the aerosol particles 90 from which the scattered light Sᵢ₊₁ thus detected originates are present and the point in time tᵢ₊₁ at which the scattered light Sᵢ₊₁ was received (S40).

Next, by controlling the light source 10, the controller 150 scans an area around the unit space in which the scattered light Sᵢ₊₁ was generated (S42). For example, in a case where scattered light L2 from the unit space 96 shown in FIG. 7 has been received as the scattered light Sᵢ₊₁, the controller 150 causes the light source 10 to radiate the irradiating light L1 toward the unit space 97 adjacent to the unit space 96. In this way, a search is made for a place to which the aerosol particles 90 present in the unit space 96 move.

Next, the photodetector 30 receives scattered light Sᵢ₊₂ (S44) and outputs a second signal corresponding to the intensity sᵢ₊₂ of the scattered light Sᵢ+2. On the basis of the second signal, the signal processing circuit 40 stores, in the memory, the position pᵢ₊₂ of a unit space in which the aerosol particles 90 from which the scattered light Sᵢ₊₂ thus detected originates are present and the point in time tᵢ₊₂ at which the scattered light Sᵢ₊₁ was received (S46).

Next, on the basis of the position pᵢ₊₁, the point in time tᵢ₊₁, the position pᵢ₊₂, and the point in time tᵢ₊₂ stored in the memory, the signal processing circuit 40 calculates the velocity v of the aerosol particles 90 (S48). Specifically, the signal processing circuit 40 calculates the velocity vᵢ of the aerosol particles 90 on the basis of Formula (2) as follows:

$${v}_{i} = \frac{\vert {p}_{i + 2} - {p}_{i + 1} \vert}{{t}_{i + 2} - {t}_{i + 1}} \qquad ( 2 )$$

The signal processing circuit 40 predicts the initial velocity v of the aerosol particles 90 on the basis of the velocity vᵢ calculated on the basis of Formula (2) and the point in time tᵢ. For example, in a case where the difference between the point in time tᵢ and the point in time tᵢ₊₁ is sufficiently small, e.g. shorter than or equal to one second, the initial velocity v may be equal to the velocity vᵢ.

Next, the signal processing circuit 40 compares the velocity v thus predicted with the threshold v₀ (S24). In a case where the velocity v thus predicted is greater than or equal to the threshold v₀ (Yes in S24), the signal processing circuit 40 identifies the aerosol particles 90 as droplets (S26). In a case where the velocity v thus predicted is less than the threshold v₀ (No in S24), the signal processing circuit 40 identifies the aerosol particles 90 as not being droplets, and returns to step S10 to repeat the scanning of the target space.

As noted above, the present embodiment makes it possible to, even in a case where an obstacle such as the person 99 makes it impossible to acquire scattered light L2 from the aerosol particles 90, calculate the velocity of the aerosol particles 90 by searching a surrounding area. This makes it possible to accurately identify the range and direction of diffusion of the droplets, thus making it possible, for example, to create a droplet distribution map and present it to a user, as in the case of Embodiment 1. Further, since the position of the droplets is identified, it is also possible to effectively remove a virus contained in the droplets by appropriately supplying a purifying substance such as hypochlorous acid toward the droplets.

Although the present embodiment has illustrated an example in which the scatterer measurement apparatus 101 includes the sound detector 160, which detects a cough or a sneeze, this is not intended to impose any limitation. For example, the scatterer measurement apparatus 101 may include an infrared sensor or camera that detects the act of the person 99 coughing or sneezing.

Further, the sound detector 160 does not need to identify the position of the source of a cough or a sneeze. As in the case of Embodiment 1, the scatterer measurement apparatus 101 may start scanning of the target space by the controller 150 controlling the light source 10 upon detection of a cough or a sneeze. That is, the first unit space to be irradiated with the irradiating light L1 does not need to be a unit space including the mouth of the person 99 or a unit space closest to the mouth.

Further, the scatterer measurement apparatus 101 does not need to include the sound detector 160 and, as in the case of Embodiment 1, may be always scanning the target space. In this case, upon detection of the scattered light Sᵢ, the scatterer measurement apparatus 101 may perform a process starting from step S12 shown in FIG. 8.

Further, in a case where the intensity sᵢ of the scattered light Sᵢ is greater than the threshold s₀ (No in step S32 of FIG. 8), the scatterer measurement apparatus 101 may continue with the scanning of the target space without detecting the aerosol particles 90. Alternatively, in a case where the intensity sᵢ of the scattered light Sᵢ is greater than the threshold s₀ (No in step S32 of FIG. 8), the scatterer measurement apparatus 101 may return to step S30 and wait until detection of another cough.

The threshold v₀ may be a value that varies between a case where a couth has been detected by the sound detector 160 and a case where a sneeze has been detected by the sound detector 160. For example, the signal processing circuit 40 may set the threshold v₀ to 5 m/s in case where a couth has been detected by the sound detector 160, and may set the threshold v₀ to 7 m/s in a case where a sneeze has been detected by the sound detector 160.

### Embodiment 3

The following describes Embodiment 3.

As described in Embodiment 2, the position of the head of a person 99 can be identified on the basis of the intensity of light that is received. In Embodiment 3, the velocity of aerosol particles 90 that are detected around the position of the head of a person 99 is calculated on the basis of the position of the head of the person 99 and the position of the aerosol particles 90. In the following, a description is given with a focus on points of difference from Embodiment 2, and a description of common features is omitted or simplified.

A scatterer measurement apparatus according to the present embodiment is identical in configuration to the scatterer measurement apparatus 101 according to Embodiment 2. For this reason, the following description refers to the configuration of the scatterer measurement apparatus 101 according to Embodiment 2.

### 1. Detection of Aerosol Particles

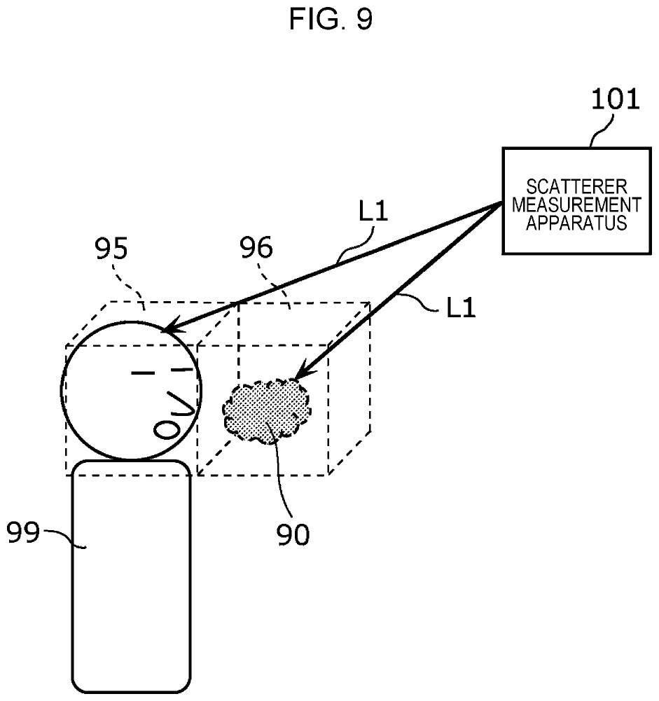

FIG. 9 is a diagram schematically showing how aerosol particles 90 are detected by the scatterer measurement apparatus 101 according to the present embodiment. As mentioned above, by detecting and storing an obstacle other than the person 99 in the target space in advance, a unit space other than a unit space stored that emits intense light can be identified as a unit space including a part of the head of the person 99. After having identified a unit space 95 including a part of the head of the person 99, the scatterer measurement apparatus 101 intensively scans an area around the unit space 95. Specifically, the scatterer measurement apparatus 101 radiates the irradiating light L1 toward each of a plurality of unit spaces adjacent to the unit space 95 and searches for a unit space in which scattered light L2 from the aerosol particles 90 is generated.

For example, in the example shown in FIG. 9, scattered light L2 is generated by the aerosol particles 90 scattering the irradiating light L1 with which a unit space 96 adjacent to the unit space 95 was irradiated. The scatterer measurement apparatus 1 calculates the velocity of the aerosol particles 90 on the basis of the point in time at which the aerosol particles 90 were generated, the point in time at which the scattered light L2 was generated, and the distance between the unit space 95 and the unit space 96.

The point in time at which the aerosol particles 90 were generated is for example a point in time at which the sound detector 160 detected a cough or a sneeze. Alternatively, the point in time at which the aerosol particles 90 were generated may be a point in time at which the infrared sensor or camera detected the act of the person 99 coughing or sneezing.

### 2. Operation

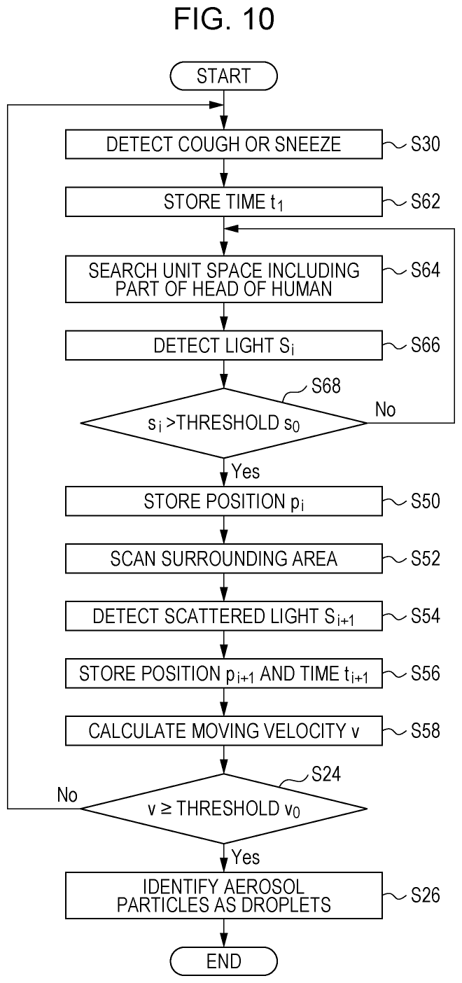

The following describes an operation of the scatterer measurement apparatus 101 according to the present embodiment with reference to FIG. 10. FIG. 10 is a flow chart showing an operation of the scatterer measurement apparatus 101 according to the present embodiment.

As shown in FIG. 10, first, the sound detector 160 detects a person 99 coughing or sneezing (S30). The controller 150 stores the point in time tᵢ at which the sound detector 160 detected the person 99 coughing or sneezing (S62). Next, by controlling the light source 10, the controller 150 causes the light source 10 to radiate the irradiating light L1 toward an area around the position in which the cough or the sneeze has occurred, thereby searching for a unit space including a part of the head of the person 99 (S64). Specifically, the photodetector 30 detects light Sᵢ and generates a first signal corresponding to the intensity sᵢ of the light Sᵢ thus detected (S66). The signal processing circuit determines, on the basis of the first signal, whether the intensity sᵢ is greater than the threshold s₀ (S68).

In a case where r the intensity sᵢ is greater than the threshold s₀ (Yes in S68), the signal processing circuit 40 stores, in the memory, the position pᵢ₊₁ of a unit space detected (S50). In a case where the intensity sᵢ is less than or equal to the threshold s₀ (No in S68), the process returns to step S44, in which a different unit space is irradiated with the irradiating light L1. The signal processing circuit 40 may identify, as a unit space including a part of the head of the person 99, a unit space located at the highest position of a plurality of unit spaces in which light whose intensity sᵢ is greater than the threshold s₀ is generated.

Next, by controlling the light source 10, the controller 150 scans an area around the unit space including a part of the head of the person 99 (S52). In this way, a search is made for aerosol particles 90 that must have been generated near the person 99. For example, the controller 150 causes the light source 10 to radiate the irradiating light L1 so that the irradiating light L1 passes through the unit space 96 adjacent to the unit space 95 shown in FIG. 9.

Next, the photodetector 30 detects scattered light Sᵢ₊₁ (S54) and outputs a second signal corresponding to the intensity sᵢ₊₁ of the scattered light Sᵢ₊₁. On the basis of the second signal, the signal processing circuit 40 stores, in the memory, the position pᵢ₊₁ of a unit space in which the aerosol particles 90 from which the scattered light Sᵢ₊₁ thus detected originates are present and the point in time tᵢ₊₁ at which the scattered light Sᵢ₊₁ was received (S56).

Next, on the basis of the position pᵢ, the point in time tᵢ, the position pᵢ₊₁, and the point in time tᵢ₊₁ stored in the memory, the signal processing circuit 40 calculates the velocity v of the aerosol particles 90 according to Formula (1) (S58). Next, the signal processing circuit 40 compares the velocity v thus calculated with the threshold v₀ (S24). In a case where the velocity v thus calculated is greater than or equal to the threshold v₀ (Yes in S24), the signal processing circuit 40 identifies the aerosol particles 90 as droplets (S26). In a case where the velocity v thus calculated is less than the threshold v₀ (No in S24), the signal processing circuit 40 identifies the aerosol particles 90 as not being droplets, returns to step S30, and waits for the sound detector 160 to detect the person 99 coughing or sneezing.

As noted above, according to the present embodiment, scattered light L2 from a unit space around a unit space 95 including a part of the head is received with the unit space 95 used as a reference position. The velocity of aerosol particles 90 is calculated according to Formula (1) on the basis of the point in time tᵢ₊₁ at which the scattered light L2 was received, the position pᵢ₊₁, the position pᵢ of the head, and the point in time tᵢ at which a cough or a sneeze was detected. This makes it possible to accurately determine whether the aerosol particles 90 are droplets.

### Embodiment 4

The following describes Embodiment 4.

Scattered light may contain, as a noise component, Rayleigh scattered light based on molecules that make up air. Embodiment 4 removes a noise component from scattered light by causing the scattered light to interfere. In the following, a description is given with a focus on points of difference from Embodiment 1, and a description of common features is omitted or simplified.

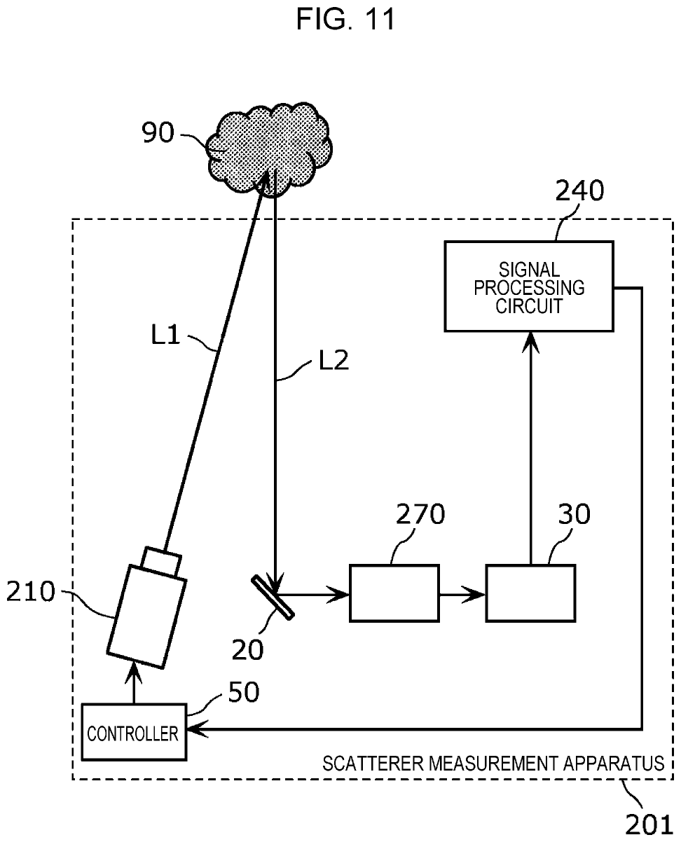

FIG. 11 is a block diagram schematically showing a configuration of a scatterer measurement apparatus 201 according to the present embodiment. As shown in FIG. 11, the scatterer measurement apparatus 201 differs from the scatterer measurement apparatus 1 according to Embodiment 1 in that the scatterer measurement apparatus 201 includes a light source 210 and a signal processing circuit 240 instead of the light source 10 and the signal processing circuit 40. Further, the scatterer measurement apparatus 201 further includes an interferer 270.

The light source 210 emits, as the irradiating light L1, multiple laser light including laser light having a plurality of peaks at equal frequency intervals LW2. The irradiating light L1 has a center wavelength X of, for example, 400 nm. The frequency intervals LW2 between the plurality of peaks are for example less than or equal to 10 GHz, and are for example 6 GHz. The full width at half maximum LW1 of each of the plurality of peaks is a value less than or equal to 1/10 of a frequency interval LW2, and is for example 360 MHz.

The frequency interval of the aforementioned multiple laser light may for example be less than or equal to 5 GHz. This makes it possible to efficiently remove an atmospheric scattering signal.

Scattered light L2, which is generated by irradiation of aerosol particles 90 with the irradiating light L1, includes Mie scattered light having a plurality of peaks at equal frequency intervals MW2. The frequency intervals MW2 are equal to the frequency intervals LW2 of the irradiating light L1. The full width at half maximum MW1 of each of the plurality of peaks is equal to the full width at half maximum LW1 of each peak of the irradiating light L1.

Further, since the scattered light L2 passes through the air, the scattered light L2 includes Rayleigh scattered light based on molecules that make up air. The full width at half maximum RW of the Rayleigh scattered light spreads due to a thermal motion of the molecules. In an actual measurement, the full width at half maximum RW of the Rayleigh scattered light ranges from approximately 3.4 GHz to 3.9 GHz. As one example, the full width at half maximum RW of the Rayleigh scattered light is 3.6 GHz.

The interferer 270 is an interferometer capable of change in optical path difference. The interferer 270 is provided on the optical path of the scattered light L2, and the scattered light L2 falls on the interferer 270. After having passed through the interferer 270, the scattered light L2 is received by the photodetector 30.

The interferer 270 splits the scattered light L2 into a plurality of scattered lights differing in optical path length from each other, and causes the plurality of scattered lights to interfere. An interferogram can be formed by receiving interfering light. The interferogram refers to interference fringes that are formed by interference. Examples of the interferer 270 include a Michelson interferometer, a Mach-Zehnder interferometer, and a Fabry-Perot interferometer.

Assume here that Ax is the interval between interference fringes in an interferogram that is generated in a case where the scattered light L2 is allowed to pass through the interferer 270. Ax is a value obtained by dividing the speed of light C(=3×10⁸ m/s) by the frequency interval MW2. For example, in a case where the frequency interval MW2 is 6 GHz and the wavelength X is 400 nm, Δx is 50 mm.

In the present embodiment, the interferer 270 sweeps an optical path difference in a range greater than ¼ of the center wavelength of the irradiating light L1 and smaller than ½ of the interval Δx between interference fringes. An optical path difference that is generated by the interferer 270 is defined as dx. An interference fringe at dx=0 is defined as a zeroth interference fringe. An interference fringe at dx=Δx is defined as a first interference fringe. An interference fringe at dx=n×Δx is defined as an nth interference fringe. In the present embodiment, a signal near the first interference fringe corresponding to the frequency interval is acquired by adjusting the optical path difference dx in the interferer 270, and the Mie scattered light is selectively acquired by removing a Rayleigh scattered light component from the signal thus acquired. The first interference fringe is minimally affected by Rayleigh scattered light based on molecules that make up air, and highly dependent on the intensity of Mie scattered light from the aerosol particles 90. Specifically, the signal strength of the first interference fringe monotonically increases according to the intensity of the Mie scattered light from the aerosol particles 90. For this reason, the intensity of the Mie scattered light from the aerosol particles 90 can be accurately acquired by measuring the signal strength of the first interference fringe.

The signal processing circuit 240 extracts a signal component corresponding to the first interference fringe from an interferogram of scattered light L2 that is obtained by sweeping the optical path difference dx and calculates the velocity on the basis of the signal component thus extracted. Specifically, the signal processing circuit 240 generates an interferogram on the basis of scattered light L2 having passed through the interferer 270. The signal processing circuit 240 can acquire the signal strength of the first interference fringe on the basis of the interferogram thus generated and, on the basis of the signal strength, can acquire the intensity of Mie scattered light received from the aerosol particles 90. This allows the signal processing circuit 240 to accurately calculate the velocity of the aerosol particles 90.

The signal processing circuit 240 may perform Fourier transform on the basis of a signal near the first interference fringe. The signal processing circuit 240 can generate wavelength spectrum data through the Fourier transform and acquire a maximum value of the wavelength spectrum data as the intensity of the Mie scattered light.

As noted above, the scatterer measurement apparatus 201 according to the present embodiment makes it possible to remove Rayleigh scattered light from scattered light L2. This makes it possible to accurately calculate the velocity of aerosol particles 90 on the basis of Mie scattered light from the aerosol particles 90.

The scatterer measurement apparatus 201 may include a condenser, provided on the optical path of the scattered light L2, that concentrates the scattered light L2. For example, one or more condensers may be provided in at least one of the space between the opening (not illustrated) through which the scattered light L2 is transmitted and the mirror 20, the space between the mirror 20 and the interferer 270, or the space between the interferer 270 and the photodetector 30.

The condenser is a lens group including at least one of a condensing lens or a collimating lens. The condenser concentrates the scattered light L2 from the aerosol particles 90, converts the scattered light L2 into parallel light, and emits the parallel light. Providing the condenser makes it possible to increase the accuracy of detection of the scattered light L2. This also makes it possible to enhance the effect of interference by the interferer 270.

### Embodiment 5

The following describes Embodiment 5.

In Embodiment 5, the type of a scatterer is identified on the basis of the depolarization ratio of the scatterer. In the following, a description is given with a focus on points of difference from Embodiment 1, and a description of common features is omitted or simplified.

### 1. Configuration

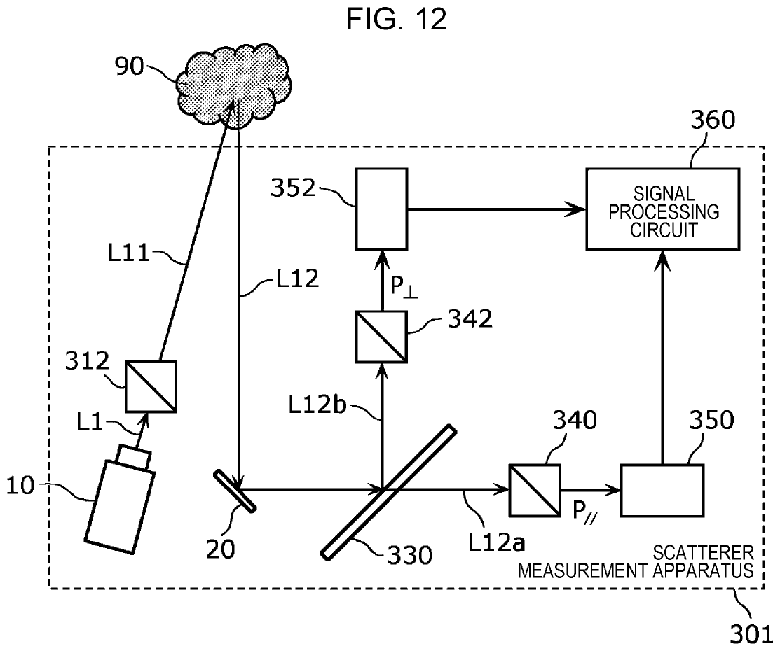

First, a brief overview of a scatterer measurement apparatus according to the present embodiment is given with reference to FIG. 12. FIG. 12 is a diagram schematically showing a configuration of a scatterer measurement apparatus 301 according to the present embodiment.

The scatterer measurement apparatus 301 according to the present embodiment irradiates a space with irradiating light, receives scattered light generated by scattering of the irradiating light by aerosol particles 90 present in the space, processes the scattered light thus received, and thereby identifies the position and type of the aerosol particles 90.

As shown in FIG. 12, the scatterer measurement apparatus 301 includes a light source 10, a polarizing filter 312, a mirror 20, a beam splitter 330, a polarizing filter 340, a polarizing filter 342, a photosensitive element 350, a photosensitive element 352, and a signal processing circuit 360. The light source 10 and the mirror 20 are the same as those of Embodiment 1.

The polarizing filter 312 is disposed on the optical path of irradiating light L1 emitted from the light source 10. The polarizing filter 312 is an example of a first polarizing filter that polarizes the irradiating light L1. Specifically, the polarizing filter 312 linearly polarizes the irradiating light L1 emitted from the light source 10. Irradiating light L11 having passed through the polarizing filter 312 is linearly-polarized light having a particular plane of polarization.

In the present embodiment, the light source 10 and the polarizing filter 312 constitute a light source that irradiates the aerosol particles 90 with the polarized irradiating light L11. As shown in FIG. 12, the aerosol particles 90 are irradiated with the polarized irradiating light L11 having passed through the polarizing filter 312. The irradiating light L11 is scattered by the aerosol particles 90, and a portion of the irradiating light L11 returns to the scatterer measurement apparatus 301 as scattered light L12. The scattered light L12 is backscattered light that is generated by the aerosol particles 90 scattering the irradiating light L11. The scattered light L12 is light based on Mie scattering effected by the aerosol particles 90.

The beam splitter 330 splits the scattered light L12 into a third scattered light L12a and a fourth scattered light L12b. The beam splitter 330 is disposed at an angle of 45 degrees with respect to the direction that the scattered light L12 travels after being reflected off the mirror 20. The beam splitter 330 transmits a portion of the scattered light L12 and emits the portion as the third scattered light L12a. The beam splitter 330 reflects the remaining portion of the scattered light L12 and emits the remaining portion as the fourth scattered light L12b. The beam splitter 330 is for example a semitransparent mirror whose transmittance and reflectance are equal to each other, and the third scattered light L12a and the fourth scattered light L12b are substantially equal in light intensity to each other. The transmittance and reflectance of the beam splitter 330 may be different from each other.

The polarizing filter 340 is an example of a second polarizing filter disposed on the optical path of the third scattered light L12a, that transmits a polarization component (hereinafter simply referred to as “parallel component”) parallel to the plane of polarization of the irradiating light L11. The polarizing filter 340 substantially blocks and does not transmit a component that is not parallel to the plane of polarization of the irradiating light L11. For this reason, after being transmitted through the polarizing filter 340, the third scattered light L12a has only a parallel one of those components which the third scattered light L12a had before being transmitted.

The polarizing filter 342 is an example of a third polarizing filter, disposed on the optical path of the fourth scattered light L12b, that transmits a polarization component (hereinafter simply referred to as “perpendicular component”) perpendicular to the plane of polarization of the irradiating light L11. The polarizing filter 342 substantially blocks and does not transmit a component that is not perpendicular to the plane of polarization of the irradiating light L11. For this reason, after being transmitted through the polarizing filter 342, the fourth scattered light L12b has only a perpendicular one of those components which the fourth scattered light L12b had before being transmitted.

The photosensitive element 350 is an example of a first photosensitive element that receives the third scattered light L12a transmitted through the polarizing filter 340. The photosensitive element 350 outputs an electrical signal corresponding to the intensity of light received. The intensity of light received by the photosensitive element 350 corresponds to the intensity of the polarization component parallel to the plane of polarization of the irradiating light L11, and is equivalent to the signal level of the electrical signal that the photosensitive element 350 outputs.

The photosensitive element 350 is for example a PMT (photomultiplier tube). Alternatively, the photosensitive element 350 may have a PMT and a photon counter. Alternatively, the photosensitive element 350 may be an avalanche photodiode (APD).

The photosensitive element 352 is an example of a second photosensitive element that receives the fourth scattered light L12b transmitted through the polarizing filter 342. The photosensitive element 352 outputs an electrical signal corresponding to the intensity of light received. The intensity of light received by the photosensitive element 352 corresponds to the intensity of the polarization component perpendicular to the plane of polarization of the irradiating light L11, and is equivalent to the signal level of the electrical signal that the photosensitive element 352 outputs. The photosensitive element 352 is identical in configuration to the photosensitive element 350.

The signal processing circuit 360 calculates the position of the aerosol particles 90 on the basis of the direction of radiation of the irradiating light L11 and the time from radiation of the irradiating light L11 to reception of the scattered light L12. The signal processing circuit 360 identifies the type of the aerosol particles 90 on the basis of the depolarization ratio of the scattered light L12 by the aerosol particles 90 and the falling velocity of the aerosol particles 90. Specifically, the signal processing circuit 360 makes a first determination on the basis of the depolarization ratio of the scattered light L12 as to whether the aerosol particles 90 are aspherical particles. Furthermore, in a case where the aerosol particles 90 has been identified as not being aspherical particles, the signal processing circuit 360 makes a second determination on the basis of the falling velocity of the aerosol particles 90 as to whether the aerosol particles 90 are PM_{2.5}. Specific processes in the signal processing circuit 360 will be described later.

As is the case with the signal processing circuit 40 according to Embodiment 1, the signal processing circuit 360 is constituted by one or more electronic circuits including a plurality of circuit components.

The constituent elements of the scatterer measurement apparatus 301 are housed, for example, in a housing (not illustrated). The housing is the outer-shell housing of the scatterer measurement apparatus 1, and has a light blocking effect. The housing is provided with an opening through which the irradiating light L11 and the scattered light L12 are allowed to pass. These openings may be provided one by one separately in correspondence with the irradiating light L11 and the scattered light L12. The scatterer measurement apparatus 301 may include an optical element such as a lens, disposed toward a light entrance side of the mirror 20, that concentrates the scattered light L12.

The placement of the constituent elements in the housing is not limited to particular placement. The constituent elements are positioned and arranged in appropriate places according to the optical paths of the irradiating light L11, the scattered light L12, the third scattered light L12a, and the fourth scattered light L12b. For example, the scatterer measurement apparatus 301 does not need to include the mirror 20, and the scattered light L12 may fall directly on the beam splitter 330. Alternatively, the scatterer measurement apparatus 301 may include a plurality of the mirrors 20.

Further, the photosensitive element 350 and the photosensitive element 352 may be different in configuration from each other. For example, the photosensitive element 352 may be higher in sensitivity than the photosensitive element 350. For example, the signal processing circuit 360 may compensate for the difference in sensitivity. Further, in a case where the transmittance and reflectance of the beam splitter 330 are different from each other, the signal processing circuit 360 may compensate for the difference between the transmittance and the reflectance.

### 2. Identification of Type of Aerosol Particles

The following describes a method for identifying the type of aerosol particles.

For example, as shown in FIG. 2, the aerosol particles 90 are droplets that are released out of the mouth of the person 99. The droplets are microdroplets that are dynamically generated by the person 99 coughing, sneezing, or uttering. The droplets may contain a virus, bacteria, or other substances.

In general, aerosol particles include not only droplets but also house dust such as grit and dust, yellow sand, air-polluting aerosols, suspended particulate matter such as PM_{2.5}, and bioparticles such as pollen, or other particles. Aerosol particles can be classified according to shape and size.

Specifically, aerosol particles can be classified into spherical particles and aspherical particles. Spherical particles include, for example, PM_{2.5}, pollen, and droplets. Aspherical particles include, for example, house dust, yellow sand, and air-polluting aerosols.

### 2-1. First Determination Based on Depolarization Ratio

The signal processing circuit 360 discriminates between spherical particles and aspherical particles on the basis of the depolarization ratio δ of the scattered light L12. The depolarization ratio δ is expressed by Formula (3) as follows:

$$δ = \frac{{P}_{⊥}}{{P}_{/ /}} \qquad ( 3 )$$

where P_{//} is the intensity of the polarization component parallel to the plane of polarization of the irradiating light L11 and is equivalent to the intensity of light received by the photosensitive element 350 and P_{⊥} is the intensity of the polarization component perpendicular to the plane of polarization of the irradiating light L11 and is equivalent to the intensity of light received by the photosensitive element 352.

In the present embodiment, the signal processing circuit 360 acquires the depolarization ratio δ on the basis of the intensity P_{//} of light received by the photosensitive element 350 and the intensity P_{⊥} of light received by the photosensitive element 352. Specifically, the signal processing circuit 360 calculates the depolarization ratio δ on the basis of Formula (3). Furthermore, the signal processing circuit 360 determines, on the basis of the depolarization ratio δ, whether the aerosol particles 90 are aspherical particles.

Scattered light L12 that is generated by spherical particles scattering the polarized irradiating light L11 maintains its plane of polarization. For this reason, the intensity P_{⊥} of light received becomes smaller, as the scattered light L12 hardly contains a perpendicular component. Accordingly, in the case of spherical particles, the depolarization ratio δ becomes smaller.

On the other hand, scattered light L12 that is generated by aspherical particles scattering the polarized irradiating light L11 does not maintain its plane of polarization. For this reason, the intensity P_{⊥} of light received becomes larger, as the scattered light L12 contains a perpendicular component. Accordingly, in the case of aspherical particles, the depolarization ratio δ becomes larger.

In the present embodiment, the signal processing circuit 360 identifies the type of the aerosol particles 90 by comparing the depolarization ratio δ with a threshold. In a case where the depolarization ratio δ is greater than or equal to the threshold, the signal processing circuit 360 identifies the aerosol particles 90 as aspherical particles. In a case where the depolarization ratio δ is less than the threshold, the signal processing circuit 360 identifies the aerosol particles 90 as not being aspherical particles, i.e. as spherical particles. The threshold is for example 10%, as the depolarization ratio δ is usually expressed as a percent.

As shown in A. Kobayashi, et al., “Consideration of Depolarization Ratio Measurements by Lidar”, Journal of the Meteorological Society of Japan, 1987, Vol. 65, No. 2, p. 303-307 and T. Murayama, et al., “Application of lidar depolarization measurement in the atmospheric boundary layer: Effects of dust and sea-salt particles”, Journal of Geophysical Research, 1999, Vol. 104, No. D24, p. 31781-31792, the depolarization ratio δ can be theoretically calculated by utilizing a back-scattering coefficient and a lidar ratio. For example, the depolarization ratio δ of microcrystals of sodium chloride, which are an example of aspherical particles, is 18%. The depolarization ratio δ of liquid drops, which are an example of spherical particles, is 0%.

Further, T. Sakai, et al., “Depolarization ratio measurement of aerosol particles produced in a laboratory chamber”, Abstracts of 27th Japanese Laser Radar Symposium, 2009, p. 94-95 discloses an example in which the depolarization ratio δ was measured in an indoor model environment. The depolarization ratio δ of yellow sand, which is an example of aspherical particles, ranges from 16% to 21%. The depolarization ratio δ of liquid drops of, for example, sodium chloride and ammonium sulfate is less than 5%.

Accordingly, setting the threshold to 10% makes it possible to accurately discriminate between aspherical particles and spherical particles. The threshold does not need to be 10%. For example, the threshold may for example be a value greater than or equal to 5% and less than 16%.

### 2-2. Second Determination Based on Falling Velocity

In a case where the aerosol particles 90 have been identified by the first determination as not being aspherical particles, the signal processing circuit 360 makes a second determination on the basis of the falling velocity of the aerosol particles 90. Specifically, the signal processing circuit 360 determines whether the aerosol particles 90 are PM_{2.5}, pollen, or droplets.

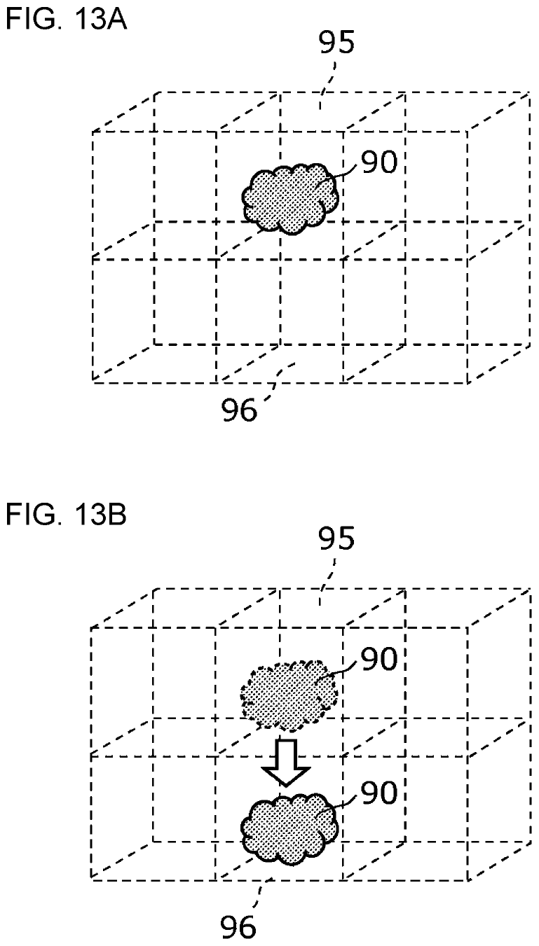

FIG. 13A is a diagram showing aerosol particles 90 during irradiation with a first irradiating light by the scatterer measurement apparatus 301 according to the present embodiment. FIG. 13B is a diagram showing the aerosol particles 90 during irradiation with a second irradiating light by the scatterer measurement apparatus 301 according to the present embodiment.

In the present embodiment, the scatterer measurement apparatus 301 irradiates the aerosol particles 90 twice with the irradiating light L11. That is, the scatterer measurement apparatus 301 radiates a first irradiating light for a first round of irradiation and a second irradiating light for a second round of irradiation. For this reason, the scatterer measurement apparatus 301 receives, in twice, scattered light L12 generated by the two rounds of irradiation with the irradiating light L11. That is, the scatterer measurement apparatus 301 receives a first scattered light produced by the first irradiating light being scattered by the aerosol particles 90 and a second scattered light produced by the second irradiating light being scattered by the aerosol particles 90.

For example, as shown in FIG. 13A, the aerosol particles 90 are located within a unit space 95 serving as an example of a first space. For this reason, by radiating a first irradiating light L11 as the first irradiating light toward the unit space 95, the scatterer measurement apparatus 301 can acquire a first scattered light L12 as the first scattered light from the aerosol particles 90.

The aerosol particles 90 freely fall under the force of gravity. Accordingly, after a certain period of time has elapsed, the aerosol particles 90 are located in a unit space 96 serving as an example of a second space, as shown in FIG. 13B. For this reason, by radiating a second irradiating light L11 as the second irradiating light toward the unit space 96, the scatterer measurement apparatus 301 can acquire a second scattered light L12 as the second scattered light from the aerosol particles 90. The unit space 96 is a space located vertically below the unit space 95.

The signal processing circuit 360 calculates the falling velocity Uₜ (unit: m/s) of the aerosol particles 90 on the basis of the distance in a vertical direction between a first position of the aerosol particles 90 at the point of time at which the first irradiating light L11 was scattered and a second position of the aerosol particles 90 at the point of time at which the second irradiating light L11 was scattered and the time interval between first reception of the scattered light L12 and second reception of the scattered light L12. The distance in a vertical direction between the first position and the second position is the fall length of the aerosol particles 90. The signal processing circuit 360 calculates the falling velocity Uₜ by dividing the fall length (unit: m) by the time interval (unit: second).

It is rare for a single aerosol particle 90 to be present alone in a space, and usually, a plurality of aerosol particles 90 are present together in a certain range. That is, the scatterer measurement apparatus 301 acquires scattered light L12 from an aggregate of a plurality of aerosol particles 90. In this case, the first position and second position of the aerosol particles 90 can for example be the center position of the aggregate. The first position and the second position may be defined for each unit space in which aerosol particles 90 are present. For example, the examples shown in FIGS. 13A and 13B assume that the aerosol particles 90 have moved one unit space in a vertical direction, as the aerosol particles 90 has moved from the unit space 95 to the unit space 96 during the two rounds of irradiation. That is, the fall length of the aerosol particles 90 is equivalent to the length of one unit space in a vertical direction.

The signal processing circuit 360 identifies the type of the aerosol particles 90 by comparing the falling velocity Uₜ thus calculated with a threshold. In the present embodiment, the signal processing circuit 360 compares the falling velocity Uₜ with each of a plurality of thresholds differing from each other. For example, in a case where the falling velocity Uₜ is less than a first threshold, the signal processing circuit 360 identifies the aerosol particles 90 as PM_{2.5}. In a case where the falling velocity Uₜ is greater than or equal to the first threshold and less than a second threshold, the signal processing circuit 360 identifies the aerosol particles 90 as pollen. In a case where the falling velocity Uₜ is greater than or equal to the second threshold, the signal processing circuit 360 identifies the aerosol particles 90 as droplets.

The first threshold is for example 0.001 m/s. The second threshold is a value greater than the first threshold. The second threshold is for example 0.1 m/s. The first threshold and the second threshold are determined on the basis of the particle diameter of the aerosol particles 90.

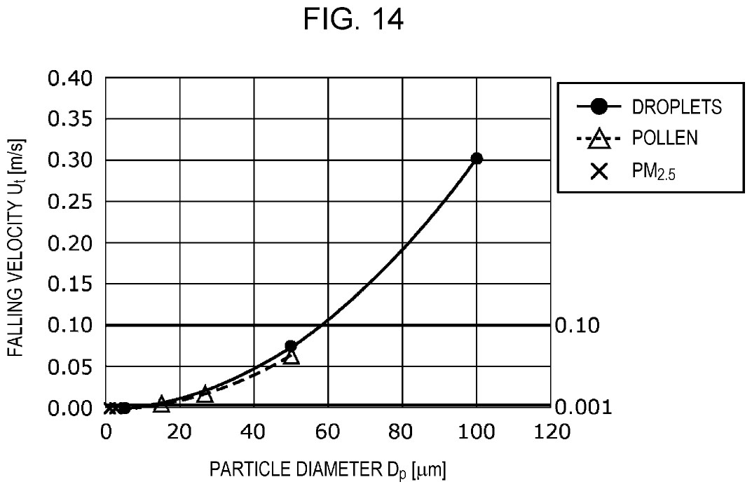

FIG. 14 is a diagram showing a relationship between the particle diameter and falling velocity of aerosol particles. In FIG. 14, the horizontal axis represents the particle diameter Dₚ (unit: μm) of aerosol particles, and the vertical axis represents the falling velocity Uₜ (unit: m/s) of aerosol particles.

As shown in FIG. 14, usually, the falling velocity Uₜ becomes higher as the particle diameter Dₚ becomes larger. The falling velocity Uₜ (unit: m/s) of each type of aerosol particle is calculated on the basis of Formula (4), which is called “Stoke's gravity settling velocity equation”:

$${U}_{t} = \frac{{ρ}_{p} {D}_{p}^{2} g}{18 μ} \qquad ( 4 )$$

where μ is a coefficient of viscosity (unit: Pa·s), pₚ is the density (unit: kg/m³) of the particles, Dₚ is the diameter (unit: m) of the particles, and g is gravitational acceleration (unit: m/s²).

Small particles such as aerosol particles quickly reach a constant velocity in a case where they freely fall with the force of gravity in still air. This constant velocity is called “terminal settling velocity”, which is the falling velocity Uₜ expressed by Formula (4). Formula (4) requires that fluid resistance acting on aerosol particles freely falling at a constant velocity be balanced with gravity.

Of spherical particles such as PM_{2.5}, pollen, and droplets, PM_{2.5} have the smallest particle diameter Dₚ. The particle diameter Dₚ of PM_{2.5} is for example less than or equal to 2.5 μm. As one example, the time required for particles with a particle diameter of 1 μm to fall 1 m is approximately 9 hours in a windless state. When calculated using Formula (4), the falling velocity Uₜ of particles with a particle diameter of 1 μm is 3.0×10⁻⁵ m/s. The falling velocity Uₜ of particles with a particle diameter of 2.5 μm is 1.9×10⁻⁴ m/s.

The particle diameter Dₚ of PM_{2.5} ranges from 10 μm to 50 μm. As one example, the average particle diameter Dₚ of cedar pollen is 27 μm. The time required for this pollen to fall 1 m is approximately one minute. When calculated using Formula (4), the falling velocity Uₜ of pollen with a particle diameter of 15 μm is 5.9×10⁻³ m/s. The falling velocity Uₜ of pollen with a particle diameter of 50 μm is 6.5×10⁻² m/s.

The particle diameter Dₚ of droplets ranges from 5 μm to 100 μm. For example, the time required for droplets with a particle diameter of 100 μm to fall 1 m is approximately thirty seconds. When calculated using Formula (4), the falling velocity Uₜ of droplets with a particle diameter of 100 μm is 0.30 m/s. Usually, droplets released out of the mouth of the person 99 contain a certain amount of large-size droplets with a particle diameter Dₚ of approximately 100 μm. For this reason, in a case where aerosol particles 90 having a high falling velocity Uₜ are contained in an aggregate of aerosol particles 90, the aerosol particles 90 contained in the aggregate can be identified as droplets. It should be noted that S. Kato, “Investigation on Characteristics of Transportation of Coughed Spit in a Room”, Nagare, Vol. 26, 2007, p. 331-339 discloses an example in which a relationship between the particle diameter and falling velocity of droplets was actually measured.

Accordingly, the first threshold for identification of PM_{2.5} is for example 0.001 m/s. The first threshold may be a value greater than or equal to 2×10⁻⁴ m/s and less than or equal to 5×10⁻³ m/s. The second threshold for identification of droplets is for example 0.1 m/s. The second threshold may be a value greater than or equal to 0.07 m/s and less than or equal to 0.29 m/s.

Although an example has been illustrated here in which by radiating the second irradiating light L11, the scatterer measurement apparatus 301 has successfully acquired scattered light L12 from aerosol particles 90 that have fallen, this is not intended to impose any limitation. The scatterer measurement apparatus 301 may radiate the irradiating light L11 three or more times. By deeming irradiating light L11 that led to successful acquisition of scattered light L12 to be a “second irradiating light L11”, the signal processing circuit 360 can calculate the falling velocity in a manner similar to the aforementioned process.

Further, in a case where the aerosol particles 90 are PM_{2.5}, scattered light L12 may not be acquired even by irradiating the unit space 96 with the irradiating light L11, as the aerosol particles 90 hardly fall. In this case, the third or subsequent irradiating light L11 may be radiated toward a space partially overlapping the unit space 95. For example, a space including the lower half of the unit space 95 shown in FIG. 13A and the upper half of the unit space 96 may be irradiated with the irradiating light L11. In other words, the second space, which is irradiated with the second or subsequent irradiating light L11, may be located vertically below the first space and partially overlap the first space.

Further, in case where falling of the aerosol particles 90 is not detected even after a certain period of time has elapsed, the signal processing circuit 360 may identify the aerosol particles 90 as PM_{2.5}. For example, in a case where the aerosol particles 90 are not detected in the unit space 96 during a certain period of time after the aerosol particles 90 have been detected in the unit space 95, the scatterer measurement apparatus 301 radiates the irradiating light L11 toward the unit space 95 after the period of time has elapsed. In a case where the aerosol particles 90 have been detected at this point in time, the signal processing circuit 360 may determine that the aerosol particles 90 have not fallen and identify the aerosol particles 90 as PM_{2.5}.

### 3. Operation

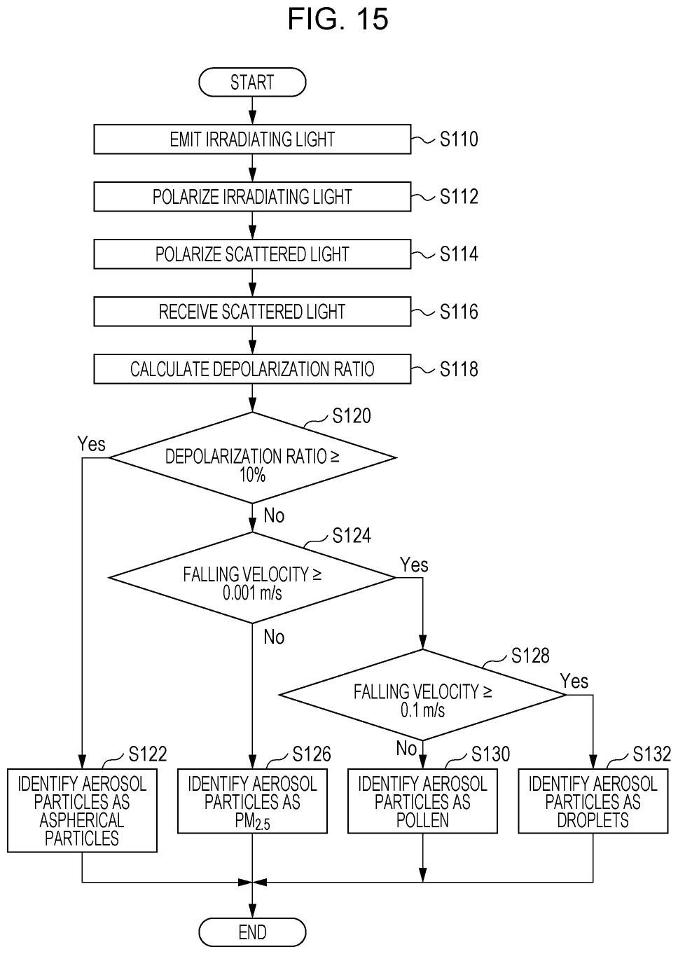

The following describes an operation of the scatterer measurement apparatus 301, i.e. a scatterer measurement method, according to the present embodiment with reference to FIG. 15. FIG. 15 is a flow chart showing an operation of the scatterer measurement apparatus 301 according to the present embodiment.

As shown in FIG. 15, first, the light source 10 emits the irradiating light L1 (S110). Next, the polarizing filter 312 polarizes the irradiating light L1 (S112). Polarized irradiating light L11 is emitted out of the scatterer measurement apparatus 301. In a case where aerosol particles 90 are present in the direction of radiation of the irradiating light L11, scattered light is generated by the aerosol particles 90 scattering the irradiating light L11. Of the scattered light thus generated, scattered light L12, which is backscattered light, returns to the scatterer measurement apparatus 301.

Next, in the scatterer measurement apparatus 301, the polarizing filter 340 and the polarizing filter 342 polarize the scattered light L12 (S114). Specifically, after the beam splitter 330 has split the scattered light L12 into a third scattered light L12a and fourth scattered light L12b, the polarizing filter 340 transmits a polarization component of the third scattered light L12a parallel to the plane of polarization of the irradiating light L11, and the polarizing filter 342 transmits a polarization component of the fourth scattered light L12b perpendicular to the plane of polarization of the irradiating light L11.

Next, the photosensitive element 350 receives the third scattered light L12a transmitted through the polarizing filter 340, and the photosensitive element 352 receives the fourth scattered light L12b transmitted through the polarizing filter 342 (S116). The photosensitive element 350 generates an electrical signal corresponding to the intensity P_{//} of light received of a parallel component contained in the scattered light L12 and outputs the electrical signal to the signal processing circuit 360. The photosensitive element 352 generates an electrical signal corresponding to the intensity P_{⊥} of light received of a perpendicular component contained in the scattered light L12 and outputs the electrical signal to the signal processing circuit 360.

Next, the signal processing circuit 360 calculates the depolarization ratio δ according to Formula (3) on the basis of the intensity P_{//} of light received by the photosensitive element 350 and the intensity P_{⊥} of light received by the photosensitive element 352 (S118). Next, the signal processing circuit 360 compares the depolarization ratio δ with the threshold (S120). The threshold here is for example 10%.

In a case where the depolarization ratio δ is greater than or equal to 10% (Yes in S120), the signal processing circuit 360 identifies the aerosol particles 90 as aspherical particles (S122). Specifically, the signal processing circuit 360 identifies the aerosol particles 90 as yellow sand or house dust.

In a case where the depolarization ratio δ is less than 10% (No in S120), the signal processing circuit 360 identifies the aerosol particles 90 as not being aspherical particles and determines the falling velocity of the aerosol particles 90 (S124). Specifically, the signal processing circuit 360 calculates the falling velocity Uₜ of the aerosol particles 90 on the basis of the time interval between first reception of the scattered light L12 and second reception of the scattered light L12 and the fall length of the aerosol particles 90. The signal processing circuit 360 compares the falling velocity Uₜ thus calculated with the first threshold for identification of PM_{2.5}. The first threshold here is for example 0.001 m/s.

In a case where the falling velocity Uₜ is less than 0.001 m/s (No in S124), i.e. in a case where it can be deemed that the aerosol particles 90 have not substantially fallen, the signal processing circuit 360 identifies the aerosol particles 90 as PM_{2.5} (S126). In a case where the falling velocity Uₜ is greater than or equal to 0.001 m/s (Yes in S124), the signal processing circuit 360 identifies the aerosol particles 90 as not being PM_{2.5} and compares the falling velocity Uₜ with the second threshold (S128). The second threshold here is for example 0.1 m/s.

In a case where the falling velocity Uₜ is less than 0.1 m/s (No in S128), the signal processing circuit 360 identifies the aerosol particles 90 as pollen (S130). In a case where the falling velocity Uₜ is greater than or equal to 0.1 m/s (Yes in S128), the signal processing circuit 360 identifies the aerosol particles 90 as droplets (S132).

The scatterer measurement apparatus 301 repeatedly performs the process from step S110 to S132 while changing the direction of radiation of the irradiating light L11. For example, in a case where each of the plurality of unit spaces in the target space is irradiated with the irradiating light L11 and scattered light L12 has been successfully received, the position and type of aerosol particles 90 from which the scattered light L12 was generated are identified. This allows the scatterer measurement apparatus 301 to generate a distribution map that indicates the position and type of the aerosol particles 90 within in the target space. Thus, the present embodiment makes it possible to accurately identify the position and type of the aerosol particles 90.

### Embodiment 6

The following describes Embodiment 6.

Embodiment 5 has illustrated an example in which pollen and droplets are discriminated between by comparing the falling velocity with the second threshold. In Embodiment 6, on the other hand, droplets and pollen are discriminated between by utilizing fluorescence emitted by aerosol particles to be detected. In the following, a description is given with a focus on points of difference from Embodiment 5, and a description of common features is omitted or simplified.

### 1. Configuration

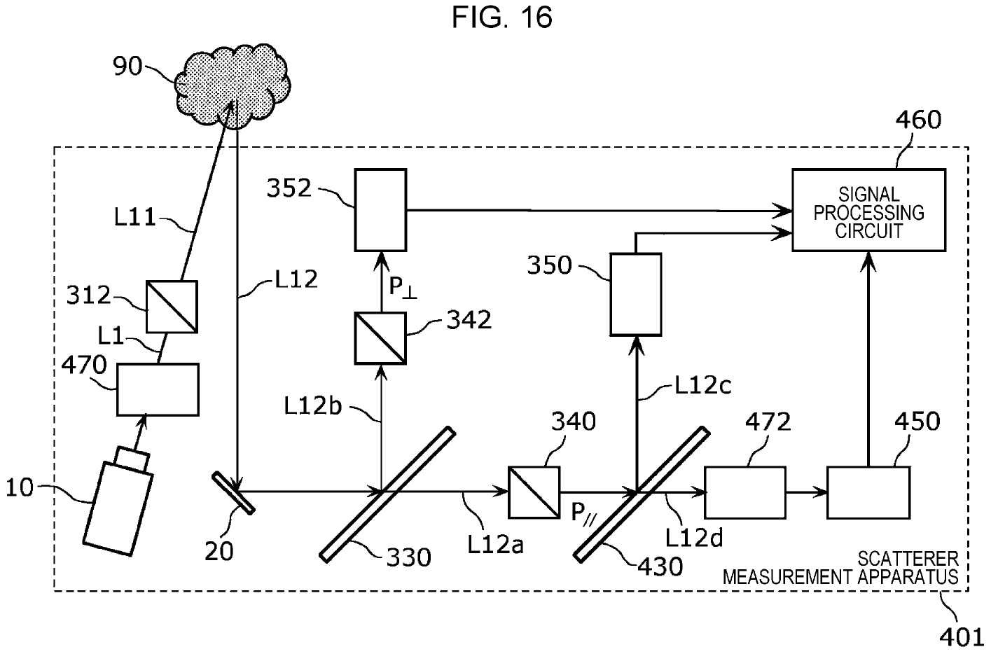

FIG. 16 is a diagram schematically showing a configuration of a scatterer measurement apparatus 401 according to the present embodiment. As shown in FIG. 16, the scatterer measurement apparatus 401 differs from the scatterer measurement apparatus 301 according to Embodiment 5 in that the scatterer measurement apparatus 401 includes a signal processing circuit 460 instead of the signal processing circuit 360. Further, the scatterer measurement apparatus 401 further includes a beam splitter 430, a photosensitive element 450, a disperser 470, and a disperser 472. The following describes the newly-added constituent elements in sequence along a path of light.

The disperser 470 disperses light emitted by the light source 10 and thereby causes light having a particular wavelength component to be emitted as irradiating light L1. The irradiating light L1 emitted from the disperser 470 is polarized by the polarizing filter 312 and radiated toward a space as polarized irradiating light L11. The polarized irradiating light L11 has the same wavelength component as the unpolarized irradiating light L1.

In the present embodiment, the irradiating light L11 is light that does not contain a fluorescence wavelength component of droplets. As will be described in detail later, the fluorescence wavelength component of droplets is light in a band of wavelengths longer than or equal to approximately 300 nm and shorter than or equal to approximately 410 nm.

The irradiating light L11 is excitation light that excites organic matter, such as amino acid, that makes up pollen. Specifically, the irradiating light L11 is light having a peak in a band of wavelengths longer than or equal to 300 nm and shorter than or equal to 500 nm. As one example, the irradiating light L11 is light having a peak at 355 nm. That is, the particular wavelength component is for example 355 nm.

As will be described in detail later, irradiating light L11 having a peak at 355 nm strongly excites pollen but hardly excites droplets. Whereas pollen emits intense fluorescence when irradiated with irradiating light L11 having a peak at 355 nm, droplets hardly emit fluorescence when irradiated with irradiating light L11 having a peak at 355 nm. This makes it possible to discriminate between pollen and droplets on the basis of the intensity of fluorescence received.

An example of the disperser 470 is, but is not limited to, a diffraction grating or a prism. The disperser 470 may be a bandpass filter that transmits only a particular band of wavelengths.

The beam splitter 430 splits the third scattered light L12a transmitted through the polarizing filter 340 into two third scattered lights L12c and L12d. The beam splitter 430 is disposed at an angle of 45 degrees with respect to the direction that the third scattered light L12a travels after having passed through the polarizing filter 340. The beam splitter 340 transmits a portion of the third scattered light L12a and emits the portion as the third scattered light L12c. The beam splitter 430 reflects the remaining portion of the third scattered light L12a and emits the remaining portion as the third scattered light L12d.

The beam splitter 430 is for example a semitransparent mirror whose transmittance and reflectance are equal to each other, and the third scattered light L12c and the third scattered light L12d are substantially equal in light intensity to each other. In this case, the third scattered light L12c, which is inputted to the photosensitive element 350, becomes half the intensity of the third scattered light L12a. For this reason, the signal processing circuit 460 makes a correction by doubling the signal level of an electrical signal that is outputted from the photosensitive element 350. This allows the signal processing circuit 460 to calculate the depolarization ratio δ using Formula (3) as in the case of Embodiment 5. Alternatively, there may be provided an amplifier that amplifies the electrical signal that is emitted from the photosensitive element 350.

Alternatively, the transmittance and reflectance of the beam splitter 330 may be different from each other. For example, the transmittance of the beam splitter 330 is reduced to ⅔, and the reflectance to ⅓. In this case, the intensity of the fourth scattered light L12b, which is light reflected by the beam splitter 330, becomes half the intensity of the third scattered light L12a, which is transmitted light. This causes the third scattered light L12c and the fourth scattered light L12b to be equal in ratio of intensity, thus allowing the signal processing circuit 460 to calculate the depolarization ratio δ as in the case of Embodiment 5. The transmittance and reflectance of the beam splitter 430 may be different from each other.

The disperser 472 disperses the third scattered light L12d and thereby causes light having a particular wavelength component to fall on the photosensitive element 450. In the present embodiment, the third scattered light L12d thus dispersed is light having a wavelength component longer than or equal to 400 nm and shorter than or equal to 1000 nm.

Specifically, the disperser 472 transmits light having a wavelength component of fluorescence emitted by pollen upon irradiation with excitation light and blocks transmission of light having other wavelength components. For example, the disperser 472 blocks light having a wavelength component of fluorescence emitted by droplets upon irradiation with excitation light. Further, the disperser 472 blocks light having a wavelength component of the irradiating light L11. This allows only fluorescence emitted by pollen to fall on the photosensitive element 450, so that an identification of pollen can be easily made on the basis of the intensity of light received by the photosensitive element 450.

An example of the disperser 472 is, but is not limited to, a diffraction grating or a prism. The disperser 472 may be a bandpass filter that transmits only a particular band of wavelengths.

The photosensitive element 450 is an example of a third photosensitive element that receives the third scattered light L12d dispersed by the disperser 472. The photosensitive element 450 outputs an electrical signal corresponding to the intensity of light received. The intensity of light received by the photosensitive element 450 corresponds to the intensity of a fluorescence component of a particular wavelength contained in the scattered light L12, and is equivalent to the signal level of the electrical signal that the photosensitive element 450 outputs. The photosensitive element 450 is identical in configuration, for example, to the photosensitive element 350.

As is the case with the signal processing circuit 360 according to Embodiment 5, the signal processing circuit 460 calculates the depolarization ratio δ and the falling velocity Uₜ. Furthermore, the signal processing circuit 460 makes a first determination based on the depolarization ratio δ and a second determination based on the falling velocity Uₜ. In the present embodiment, the signal processing circuit 460 differs from the signal processing circuit 360 in that the signal processing circuit 460 performs a different process in a case where the falling velocity Uₜ is greater than or equal to the first threshold in the second determination. Specifically, in a case where the falling velocity Uₜ is greater than or equal to the first threshold, the signal processing circuit 460 determines, on the basis of fluorescence intensity, whether the aerosol particles 90 are pollen or droplets. Specific processes in the signal processing circuit 460 will be described later.

### 2. Determination Based on Fluorescence Intensity

The following describes a method for identifying the type of aerosol particles 90 on the basis of fluorescence intensity.

The scatterer measurement apparatus 401 according to the present embodiment identifies the type of the aerosol particles 90 by utilizing a difference in fluorescence intensity between pollen and droplets. The following describes three-dimensional fluorescence spectral of pollen and droplets. A three-dimensional fluorescence spectrum, also called “excitation fluorescence matrix (EEM: Excitation-Emission Matrix)” or “fluorescence fingerprint”, is information that indicates the intensity of light received with respect to a combination of an excitation wavelength and the wavelength of light received.

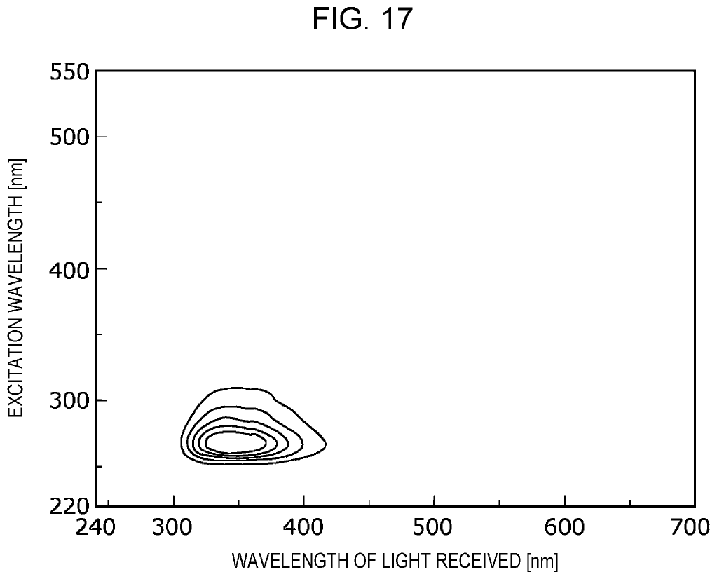

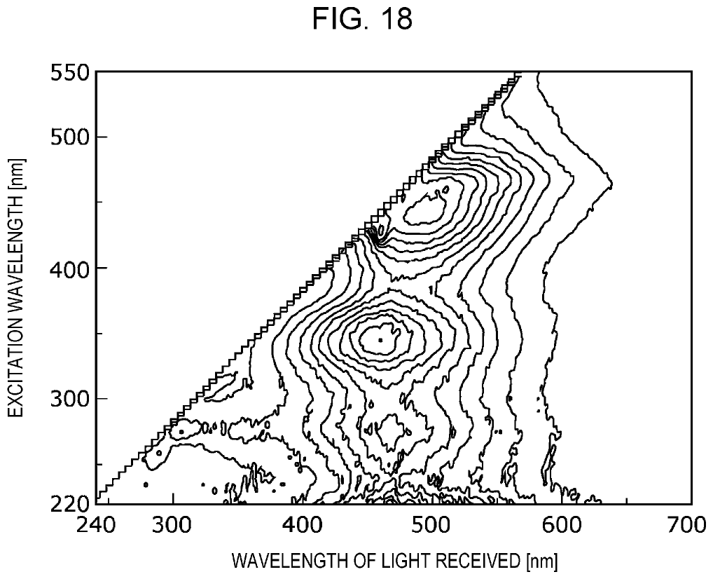

FIG. 17 is an example of a three-dimensional florescence spectrum of saliva. FIG. 18 is an example of a three-dimensional florescence spectrum of cedar pollen. In each of FIGS. 17 and 18, the horizontal axis represents the wavelength of light received (unit: nm), and the vertical axis represents the excitation wavelength (unit: nm). Solid lines drawn in a graph region defined by the vertical axis and the horizontal axis are isointensity lines of the intensity of light received.

In the example shown in FIG. 17, when irradiated with excitation light in a band of wavelengths ranging from approximately 250 nm to approximately 310 nm, saliva emits fluorescence in a band of wavelengths ranging from approximately 300 nm to approximately 410 nm. When irradiated with excitation light in a band of wavelengths ranging from approximately 260 nm to approximately 280 nm, saliva emits high-intensity fluorescence in a band of wavelengths ranging from approximately 320 nm to approximately 370 nm. A peak wavelength of excitation light with respect to saliva is approximately 260 nm, and when irradiated with excitation light having the peak wavelength, saliva emits fluorescence with a peak wavelength of approximately 350 nm. Droplets are microdroplets of saliva released out of the mouth. Accordingly, a three-dimensional fluorescence matrix of droplets is the same as a three-dimensional fluorescence matrix of saliva.

In the example shown in FIG. 18, when irradiated with excitation light in a band of wavelengths ranging from approximately 320 nm to approximately 370 nm, cedar pollen emits intense fluorescence in a band of wavelengths ranging from approximately 430 nm to approximately 490 nm. A peak wavelength of excitation light with respect to cedar pollen is approximately 350 nm, and when irradiated with excitation light having the peak wavelength, cedar pollen emits fluorescence with a peak wavelength of approximately 460 nm. Further, when irradiated with excitation light in a band of wavelengths ranging from approximately 420 nm to approximately 470 nm, cedar pollen emits intense fluorescence in a band of wavelengths ranging from approximately 470 nm to approximately 520 nm. A peak wavelength of excitation light with respect to cedar pollen is approximately 450 nm, and when irradiated with excitation light having the peak wavelength, cedar pollen emits fluorescence with a peak wavelength of approximately 500 nm.

As shown in FIGS. 17 and 18, saliva, i.e. droplets, and pollen are different in intensity of fluorescence that is emitted upon irradiation with excitation light of a particular wavelength. In the present embodiment, droplets and pollen can be discriminated between on the basis of the wavelength of the irradiating light L11 radiated as excitation light, the wavelength of the scattered light L12 received, which is fluorescence, and the intensity of the scattered light L12 received.

For example, as shown in FIG. 17, droplets do not emit fluorescence in a case where the wavelength of the irradiating light L11 dispersed by the disperser 470 is 355 nm. On the other hand, as shown in FIG. 18, pollen emits fluorescence with a wavelength of approximately 460 nm in a case where the wavelength of the irradiating light L11 is 355 nm.

It is assumed here that the disperser 472 is a bandpass filter that allows passage of a band of wavelengths longer than or equal to 400 nm and shorter than or equal to 1000 nm. In a case where the aerosol particles 90 are pollen, the third scattered light L12d falls on the photosensitive element 450 at a predetermined intensity. At this point in time, the wavelength component of the irradiating light L11 contained in the third scattered light L12d is blocked by the disperser 472. Accordingly, only a fluorescence component based on pollen falls on the photosensitive element 450.

Meanwhile, in a case where the aerosol particles 90 are droplets, the intensity of the third scattered light L12d is sufficiently low, as the droplets do not emit fluorescence. Further, even in a case where the wavelength component of the irradiating light L11 is contained in the third scattered light L12d, the wavelength component of the irradiating light L11 is blocked by the disperser 472. Accordingly, the third scattered light L12d is hardly detected by the photosensitive element 450.

Accordingly, by comparing the intensity of light received by the photosensitive element 450 with a threshold, the signal processing circuit 460 can determine whether the aerosol particles 90 are pollen or droplets. Specifically, in a case where the intensity of light received by the photosensitive element 450 is greater than the threshold, the signal processing circuit 460 identifies the aerosol particles 90 as pollen. In a case where the intensity of light received by the photosensitive element 450 is less than or equal to the threshold, the signal processing circuit 460 identifies the aerosol particles 90 as droplets. An example of the threshold is, but is not limited to, 0.

### 3. Operation

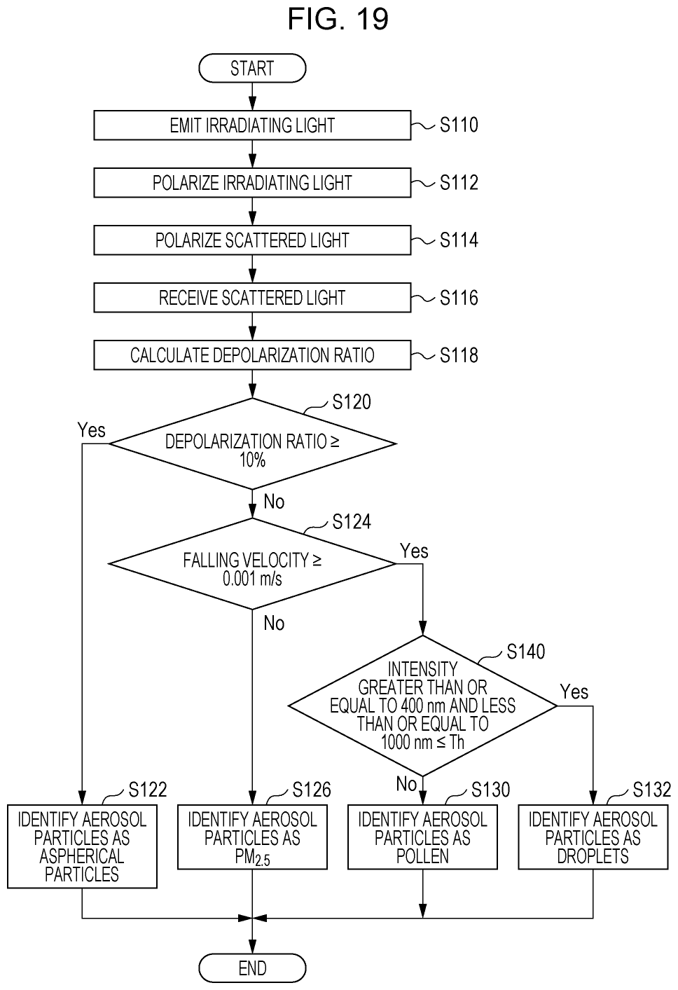

The following describes an operation of the scatterer measurement apparatus 401, i.e. a scatterer measurement method, according to the present embodiment with reference to FIG. 19. FIG. 19 is a flow chart showing an operation of the scatterer measurement apparatus 401 according to the present embodiment.

As shown in FIG. 19, the process up to the step (S124) in which the signal processing circuit 460 compares the falling velocity Uₜ with the first threshold is the same as the process described with reference to FIG. 15 in Embodiment 5. In the scatterer measurement apparatus 401 according to the present embodiment, the signal processing circuit 460 compares fluorescence intensity with a threshold Th (S140) in a case where the falling velocity Uₜ is greater than or equal to the first threshold (Yes in S124). The threshold Th is for example 0.

Specifically, the disperser 472 disperses the third scattered light L12d to cause only a wavelength component longer than or equal to 400 nm and shorter than or equal to 1000 nm to fall on the photosensitive element 450. As a result, the intensity of light received by the photosensitive element 450 is equivalent to the intensity of the wavelength component longer than or equal to 400 nm and shorter than or equal to 1000 nm contained in the scattered light L12 from the aerosol particles 90. In a case where the intensity of the wavelength component longer than or equal to 400 nm and shorter than or equal to 1000 nm thus received is greater than the threshold Th (No in S140), the signal processing circuit 460 identifies the aerosol particles 90 as pollen. In a case where the intensity of the wavelength component longer than or equal to 400 nm and shorter than or equal to 1000 nm thus received is less than or equal to the threshold Th (Yes in S140), the signal processing circuit 460 identifies the aerosol particles 90 as droplets.

The present embodiment, which does not use the falling velocity for identification of pollen and droplets, makes it possible to accurately discriminate between droplets and pollen regardless of the particle diameter size of droplets. Specifically, the present embodiment makes it possible to identify even droplets smaller in size than pollen.

Further, the signal processing circuit 460 may generate a three-dimensional fluorescence matrix on the basis of the intensity of light received by the photosensitive element 450 and the wavelength of the irradiating light L11 and discriminate between pollen and droplets on the basis of the three-dimensional fluorescence matrix thus generated. Specifically, the intensity of light received for each wavelength of light received may be acquired by irradiating the aerosol particles 90 with a plurality of irradiating lights L11 containing wavelength components differing from each other and splitting the third scattered light L12a into a plurality of wavelengths of light received differing from each other. As a result, the signal processing circuit 460 generates a three-dimensional fluorescence matrix based on excitation wavelength, the wavelength of light received, and the intensity of light received.

The three-dimensional fluorescence spectra of pollen and droplets as shown in FIGS. 17 and 18 are stored in advance in a memory of the signal processing circuit 460. The signal processing circuit 460 can more accurately discriminate between droplets and pollen by comparing the three-dimensional fluorescence matrix thus generated with three-dimensional fluorescence matrix stored in the memory.

Further, for example, in a case where the intensity of light received by the photosensitive element 450 is greater than the threshold even in a case where the depolarization ratio δ is greater than or equal to the threshold, the signal processing circuit 460 may identify the aerosol particles 90 as pollen. Specifically, in FIG. 19, in a case where the signal processing circuit 460 has determined in S120 that the depolarization ratio δ is greater than or equal to 10% (Yes in S120), the signal processing circuit 460 may perform the process for determining fluorescence intensity, i.e. the process of step S140. This makes it possible to determine whether the aerosol particles 90 are pollen, even if the pollen has its original shape deformed.

### Embodiment 7

The following describes Embodiment 7.

Scattered light may contain, as a noise component, Rayleigh scattered light based on molecules that make up air. Embodiment 7 removes a noise component from scattered light by causing the scattered light to interfere. In the following, a description is given with a focus on points of difference from Embodiment 5, and a description of common features is omitted or simplified.

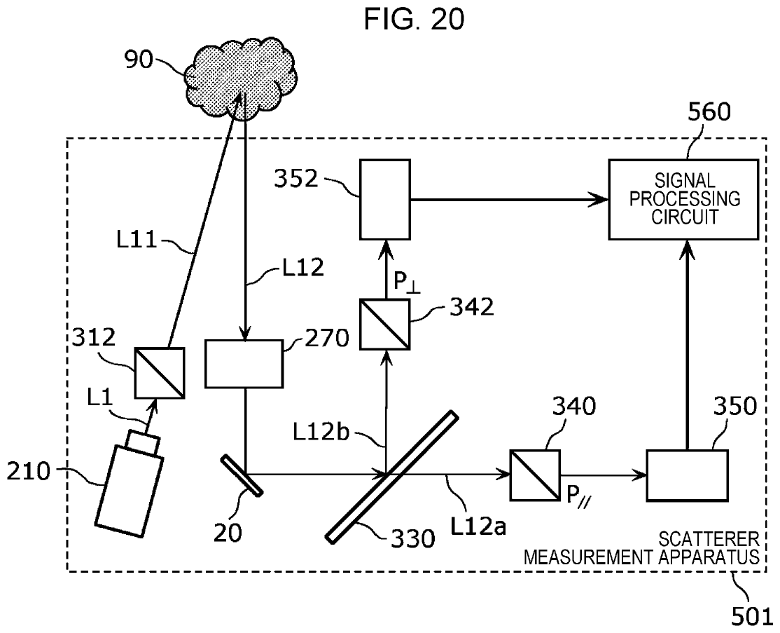

FIG. 20 is a diagram schematically showing a configuration of a scatterer measurement apparatus 501 according to the present embodiment. As shown in FIG. 20, the scatterer measurement apparatus 501 differs from the scatterer measurement apparatus 301 according to Embodiment 5 in that the scatterer measurement apparatus 501 includes a light source 210 and a signal processing circuit 560 instead of the light source 10 and the signal processing circuit 360. Further, the scatterer measurement apparatus 501 further includes an interferer 270. The light source 210 and the interferer 270 are the same as the light source 210 and the interferer 270 that the scatterer measurement apparatus 201 according to Embodiment 4 includes.

In addition to the process similar to that of Embodiment 5, the signal processing circuit 560 generates an interferogram on the basis of the scattered light L12 having passed through the interferer 270. In the present embodiment, the signal processing circuit 560 generates an interferogram for each of the third scattered light L12a and the fourth scattered light L12b. The signal processing circuit 560 can acquire the signal strength of the first interference fringe on the interferogram thus generated and the intensity of light received of a parallel component and the intensity of light received of a perpendicular component of the Mie scattered light from the aerosol particles 90 on the basis of the signal intensity. This allows the signal processing circuit 560 to accurately calculate the depolarization ratio δ.

The signal processing circuit 560 may perform Fourier transform on the basis of a signal near the first interference fringe. The signal processing circuit 560 can generate wavelength spectrum data through the Fourier transform and acquire a maximum value of the wavelength spectrum data as the intensity of the Mie scattered light.

As noted above, the scatterer measurement apparatus 501 according to the present embodiment makes it possible to remove Rayleigh scattered light from scattered light L12. This makes it possible to accurately identify the position and type of aerosol particles 90 on the basis of Mie scattered light from the aerosol particles 90.

Although the present embodiment has illustrated an example in which the interferer 270 is disposed between the mirror 20 and the aerosol particles 90, this is not intended to impose any limitation. For example, the scatterer measurement apparatus 501 may include two interferers 270. The two interferers 270 may be disposed between the beam splitter 330 and the polarizing filter 340 and 342 and between the beam splitter 330 and the polarizing filter 342, respectively. Alternatively, the two interferers 270 may be disposed between the polarizing filter 340 and the photosensitive element 350 and between the polarizing filter 342 and the photosensitive element 352, respectively.

### OTHER EMBODIMENTS

In the foregoing, scatterer measurement apparatuses and scatterer measurement methods according to one or more aspects have been described with reference to embodiments; however, the present disclosure is not intended to be limited to these embodiments. Applications to the present embodiments of various types of modification conceived of by persons skilled in the art and embodiments constructed by combining constituent elements of different embodiments are encompassed in the scope of the present disclosure, provided such applications and embodiments do not depart from the spirit of the present disclosure.

For example, the intensity of scattered light L2 from aerosol particles 90 becomes higher as the aerosol particles 90 becomes higher in concentration. For this reason, the signal processing circuit 40 can determine an increase or a decrease in the concentration of the aerosol particles 90 in a unit space on the basis of the intensity of the scattered light L2. The signal processing circuit 40 removes the intensity of scattered light before generation of droplets as a noise component from the intensity of the scattered light L2 after the generation of the droplets. The signal processing circuit 40 determines the velocity of the aerosol particles 90, with two unit spaces equal in intensity to each other after removal being a first space from which the aerosol particles 90 have moved and a second space to which the aerosol particles 90 have moved. The timing of generation of droplets is for example a point in time at which the sound detector 160 detected a cough or a sneeze.

For example, in a case where a person has coughed or sneezed toward a unit space in which other aerosol particles such as pollen are present, droplets are generated in the unit space, and the intensity of scattered light L2 from the unit space becomes higher than it had been before the droplets were generated. For this reason, on the basis of the intensity of scattered light from a unit space 95 before generation of droplets and the intensity of scattered light from the unit space 95 after the generation of the droplets, the signal processing circuit 40 can deem the difference between the two intensities as the intensity of scattered light corresponding to the droplets.

Assuming, for ease of explanation, that the intensity of scattered light Sᵢ from a unit space 95 before generation of droplets is 5 and the intensity of scattered light Si from the unit space 95 after the generation of the droplets is 15, the intensity of scattered light corresponding to the droplets is 10 (=15-5). Accordingly, in a case where a search is made through an area around the unit space, a unit space in which scattered light Sᵢ₊₁ from the unit space is 10 can be identified as a place to which the droplets have moved. For example, even if there is a unit space in which the intensity of scattered light Sᵢ₊₁ is 5, the unit space can be identified as not being a place to which the droplets have moved. This makes it possible to accurately calculate the moving velocity of the droplets.

The same applies to a case where other aerosol particles such as pollen are present in the place to which the droplets have moved. Assume, for example, a case where droplets generated in a unit space 95 in which no other aerosol particles are present have moved to a unit space 96 in which other aerosol particles are present. In this case, scattered light from the unit space 95 is scattered light based on the droplets, and has an intensity of 10. Scattered light from the unit space 96 is scattered light based on the droplets and the other aerosol particles, and has an intensity of 15. Scattered light from the unit space 96 before the generation of the droplets is scattered light based on the other aerosol particles, and has an intensity of 5. Accordingly, the intensity of the scattered light from the unit space 96 after the generation of the droplets is made 10(=15−5) by subtracting the intensity before the generation. This makes it possible to accurately detect the droplets having moved.

Further, for example, a spectroscope may be provided toward a light exit side of the light source 10, which radiates the irradiating light L1. In this way, only light having a particular wavelength component may be emitted as the irradiating light L1.

Similarly, a spectroscope may be provided toward a light entrance side of the photodetector 30. In this way, only light having a particular wavelength component may be received by the photodetector 30.

Further, for example, an infrared or visible-light image sensor may be used for detecting the person 99 coughing or sneezing. A cough or a sneeze can be detected by taking an image of an action of the person 99. Alternatively, a cough or a sneeze may be detected on the basis of an acceleration sensor attached to the person 99.

For example, the scatterer measurement apparatus 301 may discriminate between aspherical particles and PM_{2.5} and does not need to discriminate at least either pollen or droplets. For example, the signal processing circuit 360 does not need to compare the falling velocity with the second threshold. The signal processing circuit 360 may identify the aerosol particles 90 as PM_{2.5} in a case where the falling velocity is less than the first threshold and identify the aerosol particles 90 as not being PM_{2.5} in a case where the falling velocity is greater than or equal to the first threshold. That is, the scatterer measurement apparatus 301 does not need to identify whether the aerosol particles 90 are pollen or droplets.

Further, for example, for the calculation of the depolarization ratio, the aerosol particles 90 need only be irradiated at least once with the polarized irradiating light L11. That is, in a case where the aerosol particles 90 are irradiated with irradiating light more than once, the aerosol particles 90 may be irradiated only once with the polarized irradiating light L11 and, for the remaining number of times, be irradiated with the unpolarized irradiating light L1. For example, the polarizing filter 312 may be movable, and may be moved onto or out of the optical path of the irradiating light L1. Alternatively, the scatterer measurement apparatus 301 may include a plurality of the light sources 10, and no polarizing filter 312 needs to be disposed on the optical path of irradiating light L1 that is emitted from one light source 10.

Further, for example, the target space may be roughly scanned prior to detection of the aerosol particles 90, i.e. prior to reception of scattered light from the aerosol particles 90, and the target space may be finely scanned after the reception of the scattered light from the aerosol particles 90. Specifically, irradiating light may be radiated for each unit space of a large size prior to reception of scattered light from the aerosol particles 90, and irradiating light may be radiated for each unit space of a small size after the reception of the scattered light from the aerosol particles 90. In this way, the size and shape of the unit spaces may be changed at a predetermined timing during scanning of the target space.

The predetermined timing may not be detection of the aerosol particles 90 but be detection of a person. For example, in a case where at least a part of the head of a person has been detected, the size of the unit spaces may be reduced so that irradiating light may be radiated for each unit space with a focus on the vicinity of the head of the person. This makes it possible to, even in a case where the target space is wide, quickly detect the position of the head of the person by roughly scanning the target space. Detecting the position of the head of the person in advance makes it possible to easily detect droplets just released out of the mouth of the person.

In the foregoing, examples of scatterers include, but are not limited to, aerosol particles 90 such as droplets, pollen, and aspherical particles. A scatterer may contain molecules that make up the atmosphere.

Further, in each of the embodiments, a process that is executed by a particular processor may be executed by another processor. Further, the order of a plurality of processes may be changed, or a plurality of processes may be executed in parallel. Further, the assignment of the constituent elements of the scatterer measurement apparatus to the plurality of apparatuses is a mere example. For example, one apparatus may include the constituent elements of another apparatus. Further, the scatterer measurement apparatus may be implemented as a single apparatus.

For example, a process described in each of the embodiments may be realized by centralized processing using a single apparatus (system) or may be realized by decentralized processing using a plurality of apparatuses. Further, the program may be executed by a single processor or a plurality of processors. That is, centralized processing may be performed, or decentralized processing may be performed.

Further, in each of the embodiments described above, all or some of the constituent elements such as the signal processing circuit may be configured by dedicated hardware or may be realized by executing a software program suited to that constituent element. Each of the constituent elements may be realized by a program executor such as a CPU (central processing unit) or a processor reading and executing a software program stored on a storage medium such as an HDD (hard disk drive) or a semiconductor memory.

Further, a constituent element such as the signal processing circuit may be constituted by one or more electronic circuits. The one or more electronic circuits may each be a general-purpose circuit or may each be a dedicated circuit.

The one or more electronic circuits may include, for example, a semiconductor device, an IC (integrated circuit), an LSI (large-scale integrated circuit), or the like. The LSI or IC can be integrated into one chip, or also can be integrated into a plurality of chips. The name used here is LSI or IC, but it may also be called system LSI, VLSI (very large scale integration), or ULSI (ultra large scale integration) depending on the degree of integration. An FPGA (Field Programmable Gate Array) that can be programmed after manufacturing an LSI can be used for the same purpose.

It should be noted that general or specific embodiments may be implemented as a system, an apparatus, a method, an integrated circuit, or a computer program. Alternatively, general or specific embodiments may be implemented as a computer-readable non-transitory storage medium, such as an optical disk, an HDD, a semiconductor memory, having the computer program stored thereon. It should be noted that general or specific embodiments may be implemented as any selective combination of a system, an apparatus, a method, an integrated circuit, a computer program, and a storage medium.

Further, each of the embodiments described above is subject to various changes, substitutions, additions, omissions, and the like in the scope of the claims or the scope of equivalents thereof.

The present disclosure can be utilized, for example, as a scatterer measurement method and a scatterer measurement apparatus that make it possible to accurately detect the position of a scatterer, and can be utilized, for example, in an air cleaner or an air conditioner.

What is claimed is:

1. A scatterer measurement method comprising:
radiating a first irradiating light that passes through a first space in which a scatterer is present;
receiving a first scattered light produced by the first irradiating light being scattered by the scatterer;
after the scatterer has moved from the first space to a second space at least partially different from the first space, radiating a second irradiating light that passes through the second space;
receiving a second scattered light produced by the second irradiating light being scattered by the scatterer; and
calculating a velocity of the scatterer based on a difference between a first point in time at which the first scattered light was received and a second point in time at which the second scattered light was received and a distance that the scatterer moved during a period from the first point in time to the second point in time.

2. The scatterer measurement method according to claim 1, wherein the first space and the second space are each one of a plurality of unit spaces each having a predetermined shape, the plurality of unit spaces being obtained by virtually dividing a target space to be measured by the scatterer measurement method.

3. The scatterer measurement method according to claim 2, wherein the second space is a unit space, included in the plurality of unit spaces, that is adjacent to the first space.

4. The scatterer measurement method according to claim 1, wherein the first space is a space in which at least a part of a head of a person is present or a space closest to at least a part of a head of a person.

5. The scatterer measurement method according to claim 4, further comprising:
before radiating the first irradiating light, identifying the space in which the at least the part of the head is present or the space closest to the at least the part of the head as the first space.

6. The scatterer measurement method according to claim 1, further comprising:
comparing the velocity with a threshold and, in a case where the velocity is greater than or equal to the threshold, identifying the scatterer as droplets forced out of a mouth of a person.

7. The scatterer measurement method according to claim 6, wherein the threshold is 5 m/s.

8. The scatterer measurement method according to claim 1, wherein
the first irradiating light and the second irradiating light are each light having equal frequency intervals,
receiving the first scattered light includes receiving the first scattered light having passed through an interferer capable of varying optical path difference,
receiving the second scattered light includes receiving the second scattered light having passed through the interferer, and
calculating the velocity includes extracting a signal component
corresponding to a first interference fringe of each of the first scattered light and the second scattered light obtained by sweeping the optical path difference, and calculating the velocity based on the signal component.

9. The scatterer measurement method according to claim 8, wherein the optical path difference that the interferer sweeps is longer than ¼ of a center wavelength of each of the first irradiating light and the second irradiating light and shorter than ½ of an interval between interference fringes of each of the first scattered light and the second scattered light.

10. The scatterer measurement method according to claim 1, wherein
at least one selected from the group consisting of the first irradiating light and the second irradiating light is polarized light, and
the velocity is a falling velocity of the scatterer,
the scatterer measurement method further comprising measuring a depolarization ratio of scattered light corresponding to the polarized light, the scattered light being at least one selected from the group consisting of the first scattered light and the second scattered light.

11. The scatterer measurement method according to claim 10, further comprising:
making a first determination based on the depolarization ratio as to whether the scatterer is aspherical particles; and
in a case where the scatterer has been identified as not being aspherical particles, making a second determination based on the falling velocity as to whether the scatterer is PM_{2.5}.

12. The scatterer measurement method according to claim 11, wherein the first determination includes identifying the scatterer as aspherical particles in a case where the depolarization ratio is greater than or equal to 10% and identifying the scatterer as not being aspherical particles in a case where the depolarization ratio is less than 10%.

13. The scatterer measurement method according to claim 11, wherein the second determination includes identifying the scatterer as PM_{2.5} in a case where the falling velocity is less than 0.001 m/s.

14. The scatterer measurement method according to claim 13, wherein
the first irradiating light and the second irradiating light are each light not containing a fluorescence wavelength component of droplets, and
the second determination includes
(a) identifying the scatterer as pollen in a case where the falling velocity is greater than or equal to 0.001 m/s and an intensity of light received of a wavelength component longer than or equal to 400 nm and shorter than or equal to 1000 nm contained in the scattered light is greater than a threshold, and
(b) identifying the scatterer as droplets in a case where the falling velocity is greater than or equal to 0.001 m/s and the intensity of light received of the wavelength component longer than or equal to 400 nm and shorter than or equal to 1000 nm contained in the scattered light is less than or equal to the threshold.

15. The scatterer measurement method according to claim 11, wherein the second determination includes identifying the scatterer as droplets in a case where the falling velocity is greater than or equal to 0.1 m/s.

16. The scatterer measurement method according to claim 11, wherein the second determination includes identifying the scatterer as pollen in a case where the falling velocity is greater than or equal to 0.001 m/s and less than 0.1 m/s.

17. The scatterer measurement method according to claim 1, wherein the second space is located vertically below the first space.

18. A scatterer measurement apparatus comprising:
a light source that radiates a first irradiating light that passes through a first space in which a scatterer is present;
a photosensitive element that receives a first scattered light produced by the first irradiating light being scattered by the scatterer; and
a signal processing circuit, wherein
after the scatterer has moved from the first space to a second space at least partially different from the first space, the light source further radiates a second irradiating light that passes through the second space,
the photosensitive element further receives a second scattered light produced by the second irradiating light being scattered by the scatterer, and
the signal processing circuit calculates a velocity of the scatterer based on a difference between a first point in time at which the first scattered light was received and a second point in time at which the second scattered light was received and a distance that the scatterer moved during a period from the first point in time to the second point in time.

19. The scatterer measurement apparatus according to claim 18, further comprising:
a first polarizing filter that polarizes at least one selected from the group consisting of the first irradiating light and the second irradiating light radiated from the light source;
a beam splitter that splits, into a third scattered light and a fourth scattered light, scattered light corresponding to a light polarized by the first polarizing filter, the scattered light being at least one selected from the group consisting of the first scattered light and the second scattered light;
a second polarizing filter, disposed on an optical path of the third scattered light, that transmits a polarization component parallel to a plane of polarization of the light polarized by the first polarizing filter; and
a third polarizing filter, disposed on an optical path of the fourth scattered light, that transmits a polarization component perpendicular to the plane of polarization of the light polarized by the first polarizing filter, wherein
the photosensitive element includes
a first photosensitive element that receives the third scattered light having passed through the second polarizing filter, and
a second photosensitive element that receives the fourth scattered light having passed through the third polarizing filter,
the velocity is a falling velocity of the scatterer, and
the signal processing circuit further acquires a depolarization ratio based on an intensity of the third scattered light received by the first photosensitive element and an intensity of the fourth scattered light received by the second photosensitive element, determines, based on the depolarization ratio, whether the scatterer is aspherical particles, and, in a case where the scatterer has been identified as not being aspherical particles, determines, based on the falling velocity, whether the scatterer is PM_{2.5}.

20. A non-transitory computer-readable recording medium storing a program for measuring a scatterer, which when executed by a computer, causes the computer to perform an operation including:
radiating a first irradiating light that passes through a first space in which a scatterer is present;
receiving a first scattered light produced by the first irradiating light being scattered by the scatterer;
after the scatterer has moved from the first space to a second space at least partially different from the first space, radiating a second irradiating light that passes through the second space;
receiving a second scattered light produced by the second irradiating light being scattered by the scatterer; and
calculating a velocity of the scatterer based on a difference between a first point in time at which the first scattered light was received and a second point in time at which the second scattered light was received and a distance that the scatterer moved during a period from the first point in time to the second point in time.
